(19) United States
(12) Patent Application Publication
(10) Pub. No.: US 2023/0080680 A1
(43) Pub. Date: Mar. 16, 2023

(54) MODEL-BASED ANALYSIS OF INTELLECTUAL PROPERTY COLLATERAL

(71) Applicant: AON RISK SERVICES, INC. OF MARYLAND, New York, NY (US)

(72) Inventors: Brian Cochrane, Chicago, IL (US); Nicholas Joseph Chmielewski, Chicago, IL (US); Lewis C. Lee, Seattle, WA (US); Daniel Crouse, Seattle, WA (US); Giles Humphrey ffolliott Harlow, Hamilton (BM); Nicholas J. Surges, Chicago, IL (US)

(21) Appl. No.: 17/475,752

(22) Filed: Sep. 15, 2021

(51) Int. Cl. G06Q 40/02; G06Q 30/02; G06Q 40/08

(52) U.S. Cl. CPC G06Q 40/02; G06Q 30/0201; G06Q 40/08; G06N 20/00

(57) ABSTRACT

Systems and methods for model-based analysis of intellectual property (IP) collateral are disclosed. For example, IP asset data is analyzed utilizing various predictive models to generate IP assessment data and IP valuation data. This data is then utilized to facilitate the issuance of a loan that is secured utilizing the IP assets as collateral and where an insurance policy is issued to insure the lender against default by the borrower/owner of the IP assets.

### BACKGROUND

Intellectual property assets, such as patents, have a range of value to owners. Accurate valuation of intellectual property assets has historically been difficult. Described herein are improvements in technology and solutions to technical problems that can be used to, among other things, assist in the collateralization of intellectual property assets.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a schematic diagram of an example environment for model-based analysis of intellectual property (IP) collateral.

FIG. 2 illustrates a flow diagram of an example process for determining whether valuation of IP assets is sufficient for collateralization of a loan.

FIG. 3 illustrates a conceptual diagram of example IP data and resulting IP assessment data.

FIG. 4 illustrates a conceptual diagram of an example user interface for requesting IP data and displaying IP assessment data, loan data, insurance policy data, and/or rating data.

FIG. 5 illustrates a conceptual diagram of an example user interface displaying results of an analysis for identifying potential purchasers of IP assets in the event of default by the IP owner.

FIG. 6 illustrates a flow diagram of an example process for identifying trends associated with model-based analysis of IP collateral.

FIG. 7 illustrates a flow diagram of an example process for model-based analysis of IP collateral.

FIG. 8 illustrates a flow diagram of another example process for model-based analysis of IP collateral.

### DETAILED DESCRIPTION

Systems and methods for model-based analysis of intellectual property (IP) collateral are disclosed. Take, for example, an entity that owns a portfolio of IP assets. The IP assets may include patents, patent applications, trademarks including trademark registrations, copyrights including copyright registrations, trade secrets including trade secrets registered with a trade secret registry, etc. The entity may desire to acquire a loan from a lender. In examples, the lender may require and/or request that the loan be secured by the entity offering up one or more assets as collateral for the loan. Additionally, the lender may desire to mitigate the risk of default by the IP owner by acquiring an insurance policy to insure the lender in the event the IP owner defaults on the loan. Additionally, to gauge the exposure associated with the loan and/or to value the loan, a rating agency may review details associated with the loan, the borrower, and/or the insurer to provide a rating. This rating may be important for the lender and/or insurer to provide the loan and/or insurance policy, and/or the rating may be an important factor in the ability to sell the loan and/or insurance policy and/or to determine a price for the sale of the loan and/or insurance policy.

Generally, the process of a lender providing a loan, an insurer insuring against default of the loan, and rating of the loan, in a basic form, is performed with respect to real and/or personal property collateralization. This is owing primarily to the certainty surrounding the valuation of real and/or personal property as well as the prevalence of such transactions in the marketplace. However, with respect to collateralizing a loan utilizing IP assets, the process is not prevalent. To promote the use of IP assets for the collateralization of loans and particularly the ability to rate those loans by a rating agency, the present disclosure includes model-based analyses of IP assets for use as collateral against default of a loan.

To do so, an analysis platform may be established that is configured to securely communicate with entities associated with the transactions described herein. For example, the analysis platform may include a terminal where communications between devices associated with the various entities may be performed securely and with both ease of use and speed. This IP terminal may include one or more user interfaces that may be utilized by the various entities in question. For example, a potential borrower may access the IP terminal utilizing access credentials that, when entered, may display user interfaces associated with an IP owner. The user interfaces may enable the IP owner to provide details about the IP owner itself, identify IP assets associated with the IP owner, and/or to provide other information, such as information requested in association with acquiring a loan. A lender may also access the IP terminal utilizing access credentials that, when entered, may display user interfaces associated with a lender. The user interfaces may enable the lender to see IP-secured loans that the lender is associated with, see loan applications that are still in process, view data associated with IP assets used as collateral, communicate with borrowers and/or insurers, etc. An insurer may also access the IP terminal utilizing access credentials that, when entered, may display user interfaces associated with an insurer. The user interfaces may enable the insurer to see insurance policies issued to lenders, see policy applications that are still in process, view data associated with IP assets associated with secured loans, communicate with lenders, etc. A rating agency may also access the IP terminal utilizing access credentials that, when entered, may display user interfaces associated with a rating agency. The user interfaces may enable the rating agency to see loans that have been rated, view requests for ratings, view data associated with IP assets associated with secured loans and/or rated loans, communicate with lenders and/or insurers, etc. In general, the IP terminal may be utilized to request targeted, sometimes on-the-fly data, from relevant entities and to view data associated with IP-secured loans and related insurance policies.

Given the sensitive nature of the data at issue, the IP terminal may be configured to secure the transfer and/or storage of the IP asset data, IP assessment data, loan data, policy data, and/or rating data, as described more fully below. To do so, in addition to access controls such as password-secured logins, the IP terminal may encrypt and decrypt the various data described herein such that only devices registered to the appropriate entities are enabled to view and/or send the data. This encryption may include the use of tokens specifically generated for the processes and communications described herein. These tokens may be entity specific and may be produced in a computer-readable format that is not readable by humans or otherwise decryptable without the aid of a computing system.

To enable a rating agency to ultimately provide a rating on an IP-secured loan and associated insurance policy, the analysis platform may initiate a process of acquiring IP asset data. To do so, the analysis platform may generate and send a query to a device associated with a borrower requesting IP asset data. The request for IP asset data may include a request for IP asset identifiers and/or one or more identifiers of the IP owner. In other examples, the analysis system may automatically determine IP assets associated with the IP owner utilizing, in some examples, only an identifier of the IP owner and/or an identifier of one or more IP assets at issue. The analysis platform may query one or more databases, such as publicly-available IP-based databases and/or one or more registries associated with the analysis platform, for IP asset data associated with the IP assets of the borrower. In examples, one or more specific requests for IP asset data may be provided via the IP terminal. The one or more specific requests may be based on output of a trained machine learning model configured to analyze prior IP assessments and corresponding loan and/or policy terms to determine what information has impacted prior ratings. Additional details on the use of machine learning models as described here is provided below.

Once the IP asset data is acquired, an IP assessment component of the analysis platform may be configured to utilize the IP asset data to determine IP assessment data. By way of example, the IP asset data may include claims data indicating patent claims of the IP assets, specification data indicating specifications of the IP assets, figures data indicating subject matter illustrated in figures of the IP assets, file wrapper data indicating information found in a file wrapper of the IP assets, products data indicating one or more items and/or services that are offered by the IP owner, industry data indicating a technological industry in which the IP owner offers products, assignment data indicating assignment information associated with the IP assets, litigation data indicating litigation-related information associated with the IP assets, and/or other IP data as described herein. It should be understood that while several examples of IP data are provided herein, the IP data may include any data associated with IP assets of the IP owner. The IP assessment component may be configured to receive, as input, the IP asset data and to generate, as output, the IP assessment data. The IP assessment data may include any result of the analysis of the IP asset data. By way of example, the IP assessment data may include claim breadth data indicate a breadth of rights confirmed by a patent claim, a geographic reach indicating an applicability and/or strength of the IP assets in various geographic regions, assignee data indicating whether the IP assets are appropriately owned by the IP owner, timing data indicating a during of coverage of the IP assets, competitor data indicating how the IP assets compare to competitors of the IP owners, alignment data indicating how well the IP assets align with the products offered by the IP owners, validity data indicating how likely the IP assets are to be invalidated, opportunity data indicating how much opportunity the IP owner has to increase the IP portfolio and/or cover additional aspects of the technological space associated with the IP owner, exposure data indicating a likelihood that the IP assets and/or IP owner will be associated with an exposure event such as litigation, and/or other assessment data indicating an analysis of the IP assets. Additional details on the IP assessment component are provided below.

Thereafter, an IP valuation component may be utilized to determine a value of the IP assets. For example, the IP valuation component may utilize, as input, one or more of the IP assessment data and generate, as output, valuation data indicating the value of the IP assets. While additional details on the valuation of the IP assets are provided below, generally the IP valuation component may assess what a willing buyer would spend on the IP assets if sold. By way of example, an IP portfolio with many IP assets that are determined to be broad in scope, well-associated with the products offered by the IP owner, with long remaining asset terms, in diverse and/or relevant geographic regions, and without concerning issues such as assignment issues and/or litigation exposure will be valued more than an IP portfolio not having these characteristics. As part of this process, the analysis platform may identify potential purchasers of the IP assets in the event of default on a loan secured with the IP assets. These potential purchasers may be entities indicated to sell the same or similar products and/or those entities with a potential desire to expand offerings to include the products offered by the IP owner. Identification of these potential purchasers may be based at least in part on mapping data indicating aspects of the potential purchasers to the IP assets. Those potential purchasers with a mapping indicating a high degree of overlap may be considered more likely to purchase the IP assets than those will a lesser degree of overlap. Historical purchase data indicating a willingness to purchase IP assets may also be utilized when determining the potential purchasers. A probability value that a given potential purchaser will purchase the IP assets may also be provided and may also be based at least in part on the mapping. A user interface of the IP terminal may be generated that displays indicators of the potential purchasers and/or the probability values. The indicators may be presented in a ranked order such that one or more of the entities may be able to visually ascertain whether the IP assets are likely to be easily sold in the event of the IP owner defaulting on the loan.

A communications component of the analysis platform may be configured to generate and/or send communications between the entities at issue, such as by utilizing the IP terminal. The communications may be utilized to facilitate procurement of the loan from the lender to the borrower, to facilitate procurement of the insurance policy from the insurer to the lender, and/or to facilitate the rating agency providing a rating to the insurer, the lender, and/or the borrower, for example. The communications component may be configured to send data to and/or receive data from the one or more devices associated with the entities in a secure manner, such as by utilizing encryption schemes, blockchain-related techniques, and/or secure user interfaces where access to the user interfaces is restricted and access control credentials are to be received prior to a user being able to utilize the secure user interfaces.

Using the example above, the communications component may be configured to send the IP assessment data and/or IP asset data from the analysis platform to a device associated with the lender. The lender may utilize the IP assessment data and/or the IP asset data to make a determination as to whether the lender will provide a loan to the borrower, and on what terms. As described in more detail below, a terms component of the analysis platform may be utilized to determine and/or recommend certain terms associated with the loan. The communications component may also be configured to send the IP assessment data and/or the IP asset data from the analysis platform to a device associated with the insurer. The insurer may utilize the IP assessment data and/or the IP asset data to make a determination as to whether the insurer will provide an insurance policy to the lender, and on what terms. The communications component may also be configured to send details associated with the loan and/or potential loan from the lender to the insurer. Additionally, the communications component may be configured to send the IP assessment data, the IP asset data, the loan data, and/or the policy data to a device associated with the rating agency. The rating agency may utilize this data to determine a rating to attribute to the loan and/or the insurance policy.

A monitoring component of the analysis platform may be configured to monitor certain aspects of the IP assets and/or the IP owner over the term of the loan. For example, securitization of the loan utilizing the IP assets may be based on the IP valuation attributable to the IP assets. As such, it may be advantageous to ensure that the IP valuation of the IP assets does not decrease over the term of the loan and/or does not decrease below at least a threshold amount. As such, the monitoring component may be configured to periodically or otherwise collect updated IP asset data during the term of the loan and generate updated IP assessment data for the purpose of generating an updated IP valuation for the IP assets. The monitoring component may generate the updated IP valuation and may compare that updated IP valuation to the original IP valuation associated with procurement of the loan. The monitoring component may determine whether the updated IP valuation has remained constant with the original IP valuation and/or if a change has occurred. In examples where the change indicates a decrease in the IP valuation, such as by at least a threshold amount, a notification associated with the determination may be generated and sent to one or more of the entities. In examples where the updated IP valuation indicates the IP valuation has been maintained, an indication of this determination may be generated and may be made available to the entities, such as utilizing the IP terminal. Additional monitoring performed by the monitoring component may include monitoring data associated with the IP owner, monitoring competitors of the IP owner, monitoring potential purchasers of the IP assets in the event of default, etc.

A rating component of the analysis platform may be configured to perform the ratings described herein. In some examples, the rating agency may perform the rating. However, in other examples, the analysis platform itself may perform the rating and/or may perform a rating in addition to a rating provided by the rating agency. When the analysis platform performs the rating, the analysis platform may utilize, as input, the IP assessment data, the IP asset data, the loan data, and/or the policy data to determine a rating. In examples, other data such as details about the lender, the insurer, and/or the IP owner may be utilized to make the rating. The rating may represent a score and/or grade, with a more positive score and/or grade indicating that the attributes of the loan and/or insurance policy are unlikely to result in default by the borrower and/or are unlikely to result in the realization of risk by the entities involved. By contrast, a less positive score and/or grade may indicate that attributes of the loan and/or insurance policy are likely to result in default and/or are likely to result in the realization of certain risks. As used herein, the rating system may be a grade system from A to F, with A being the most positive grade and F being the least positive grade. However, it should be understood that other grading systems and/or scoring systems may be utilized.

When the analysis platform performs the rating, the rating may be based at least in part on an analysis indicating a coverage score, an opportunity score, and/or an exposure score. The coverage score may be based at least in part on one or more factors, such as geographic reach of the IP assets, expiration information associated with the IP assets, assignment information, number of active IP asset counts per year, breadth of IP coverage per asset and/or in a class of assets, breadth of IP coverage in particular technological areas and/or markets, IP portfolio diversity, alignment of the IP assets to products offered by the IP owner, and/or invalidity determination, for example. The opportunity score may be based at least in part on a frequency of IP-related filings and a trend of IP-related filings as well as expected portfolio growth. The exposure score may be based at least in part on current and/or past litigation associated with the IP assets and/or the IP owner, market-level litigation statistics, participation in non-practicing entity campaigns, and alignment of exposure to revenue streams of the IP owner, for example. Some or all of these factors may be weighted and aggregated to determine the rating. When the factors are weighted, and/or when one or more of the individual scores is weighted, machine learning techniques may be utilized to determine the weightings.

A terms component may be configured to determine and/or recommend certain terms of the loan and/or insurance policy based at least in part on the analyses described herein. For example, the IP assessment data and/or IP asset data may be utilized to determine one or more terms of the loan, such as the loan amount, interest rates, default terms, remedy terms, etc. The IP assessment data and/or IP asset data may also be utilized to determine one or more terms of the insurance policy, such as the coverage amount, premiums to be paid, percentage of loan amount recoverable on a paid-out claim, IP asset sale requirements, etc. To determine the terms as described herein, the terms component may store data associating prior IP assessment data and/or prior IP asset data with prior loans and insurance policies. Additionally, feedback data indicating details of performance of the past loans and insurance policies may be stored. This information may be utilized by the analysis platform to determine loan and/or policy terms that are affected by given IP assessment data and/or IP asset data. In examples, machine learning techniques are utilized to identify these trends and/or to generate hypothetical performance results to be utilized for recommending loan and/or policy terms for subsequent deals.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

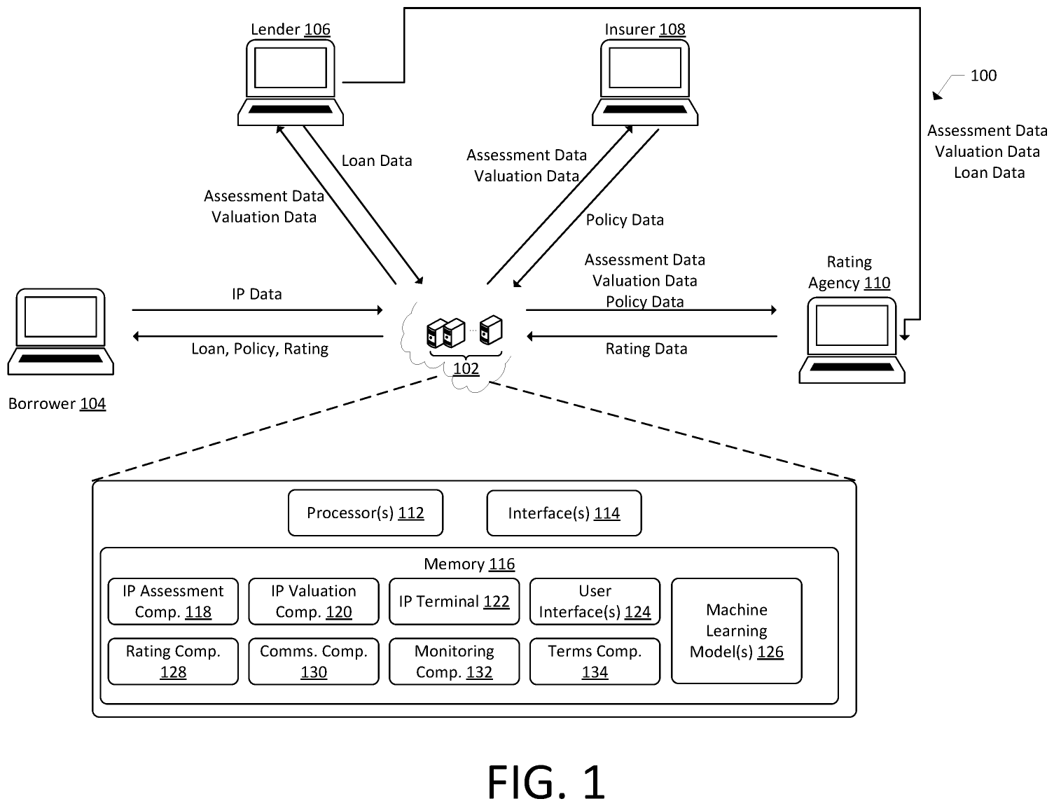

FIG. 1 illustrates a schematic diagram of an example architecture 100 of an example environment for model-based analysis of IP collateral. The architecture 100 may include, for example, an analysis platform 102, borrower device(s) 104, lender device(s) 106, insurer device(s) 108, and/or rating agency device(s) 110. Some or all of the devices and systems may be configured to communicate with each other via a network.

The analysis platform 102 may include components such as, for example, one or more processors 112, one or more network interfaces 114, and/or memory 116. The memory 116 may include components such as, for example, an IP assessment component 118, an IP valuation component 120, an IP terminal 122, one or more user interfaces 124, one or more machine learning models 126, a rating component 128, a communications component 130, a monitoring component 132, and/or a terms component 134. The devices described herein may include, for example, a computing device, a mobile phone, a tablet, a laptop, and/or one or more servers. It should be understood that the example provided herein is illustrative, and should not be considered the exclusive example of the components of the devices and/or the analysis platform 102.

To illustrate the operations performed utilizing the component of FIG. 1, the analysis platform 102 may be established and configured to securely communicate with entities associated the transactions described herein. For example, the analysis platform 102 may include the IP terminal 122 where communications between devices associated with the various entities may be performed securely and with both ease of use and speed. This IP terminal 122 may include one or more of the user interfaces 124 that may be utilized by the various entities in question. For example, a potential borrower 104 may access the IP terminal 122 utilizing access credentials that, when entered, may display user interfaces 124 associated with the borrower 104. The user interfaces 124 may enable the borrower 104 to provide details about the borrower 104 itself, identify IP assets associated with the borrower 104, and/or to provide other information, such as information requested in association with acquiring a loan. A lender 106 may also access the IP terminal 122 utilizing access credentials that, when entered, may display user interfaces 124 associated with a lender 106. The user interfaces 124 may enable the lender 106 to see IP-secured loans that the lender 106 is associated with, see loan applications that are still in process, view data associated with IP assets used as collateral, communicate with borrowers 102 and/or insurers 108, etc. An insurer 108 may also access the IP terminal 122 utilizing access credentials that, when entered, may display user interfaces 124 associated with an insurer 108. The user interfaces 124 may enable the insurer 108 to see insurance policies issued to lenders 106, see policy applications that are still in process, view data associated with IP assets associated with secured loans, communicate with lenders 106, etc. The rating agency 110 may also access the IP terminal 122 utilizing access credentials that, when entered, may display user interfaces 124 associated with the rating agency 110. The user interfaces 124 may enable the rating agency 124 to see loans that have been rated, view requests for ratings, view data associated with IP assets associated with secured loans and/or rated loans, communicate with lenders 106 and/or insurers 108, etc. In general, the IP terminal 122 may be utilized to request targeted, sometimes on the fly data, from relevant entities and to view data associated with IP-secured loans and related insurance policies. In examples, instead of or in addition to the assessment data, loan data, IP data, policy data, and/or other data being sent from the system 102 to the rating agency 110, the lender 106 may send some or all of this information to the rating agency 110.

Given the sensitive nature of the data at issue, the IP terminal 122 may be configured to secure the transfer and/or storage of the IP asset data, IP assessment data, loan data, policy data, and/or rating data, as described more fully below. To do so, in addition to access controls such as password-secured logins, the IP terminal 122 may encrypt and decrypt the various data described herein such that only devices registered to the appropriate entities are enabled to view and/or send the data.

To enable the rating agency 110 to ultimately provide a rating on an IP-secured loan and associated insurance policy, the analysis platform 102 may initiate a process of acquiring IP asset data. To do so, the analysis platform 102 may generate and send a query to a device 104 associated with a borrower requesting IP asset data. The request for IP asset data may include a request for IP asset identifiers and/or one or more identifiers of the IP owner. In other examples, the analysis platform 102 may automatically determine IP assets associated with the IP owner utilizing, in some examples, only an identifier of the IP owner and/or an identifier of one or more IP assets at issue. The analysis platform 102 may query one or more databases, such as publicly-available IP-based databases and/or one or more registries associated with the analysis platform 102, for IP asset data associated with the IP assets of the borrower 104. In examples, one or more specific requests for IP asset data may be provided via the IP terminal 122. The one or more specific requests may be based on output of a trained machine learning model 126 configured to analyze prior IP assessments and corresponding loan and/or policy terms to determine what information has impacted prior ratings. Additional details on the use of machine learning models 126 as described here will be provided below.

Once the IP asset data is acquired, an IP assessment component 118 of the analysis platform 102 may be configured to utilize the IP asset data to determine IP assessment data. By way of example, the IP asset data may include claims data indicating patent claims of the IP assets, specification data indicating specifications of the IP assets, figures data indicating subject matter illustrated in figures of the IP assets, file wrapper data indicating information found in a file wrapper of the IP assets, products data indicating one or more items and/or services that are offered by the IP owner, industry data indicating a technological industry in which the IP owner offers products, assignment data indicating assignment information associated with the IP assets, litigation data indicating litigation-related information associated with the IP assets, and/or other IP data as described herein. It should be understood that while several examples of IP data are provided herein, the IP data may include any data associated with IP assets of the IP owner. The IP assessment component 118 may be configured to receive, as input, the IP asset data and to generate, as output, the IP assessment data. The IP assessment data may include any result of the analysis of the IP asset data. By way of example, the IP assessment data may include claim breadth data indicate a breadth of rights confirmed by a patent claim, a geographic reach indicating an applicability and/or strength of the IP assets in various geographic regions, assignee data indicating whether the IP assets are appropriately owned by the IP owner, timing data indicating a during of coverage of the IP assets, competitor data indicating how the IP assets compare to competitors of the IP owners, alignment data indicating how well the IP assets align with the products offered by the IP owners, validity data indicating how likely the IP assets are to be invalidated, opportunity data indicating how much opportunity the IP owner has to increase the IP portfolio and/or cover additional aspects of the technological space associated with the IP owner, exposure data indicating a likelihood that the IP assets and/or IP owner will be associated with an exposure event such as litigation, and/or other assessment data indicating an analysis of the IP assets. Additionally details on the IP assessment component 118 are provided below.

Thereafter, the IP valuation component 120 may be utilized to determine a value of the IP assets. For example, the IP valuation component 120 may utilize, as input, one or more of the IP assessment data and generate, as output, valuation data indicating the value of the IP assets. While additional details on the valuation of the IP assets is provided below, generally the IP valuation component 120 may assess what a willing buyer would spend on the IP assets if sold. By way of example, an IP portfolio with many IP assets that are determined to be broad in scope, well-associated with the products offered by the IP owner, with long remaining asset terms, in diverse and/or relevant geographic regions, and without concerning issues such as assignment issues and/or litigation exposure will be valued more than an IP portfolio not having these characteristics. As part of this process, the analysis platform 102 may identify potential purchasers of the IP assets in the event of default on a loan secured with the IP assets. These potential purchasers may be entities indicated to sell the same or similar products and/or those entities with a potential desire to expand offerings to include the products offered by the IP owner. Identification of these potential purchasers may be based at least in part on mapping data indicating aspects of the potential purchasers to the IP assets. Those potential purchasers with a mapping indicating a high degree of overlap may be considered more likely to purchase the IP assets than those will a lesser degree of overlap. Historical purchase data indicating a willingness to purchase IP assets may also be utilized when determining the potential purchasers. A probability value that a given potential purchaser will purchase the IP assets may also be provided and may also be based at least in part on the mapping. A user interface 124 of the IP terminal 122 may be generated that displays indicators of the potential purchasers and/or the probability values. The indicators may be presented in a ranked order such that one or more of the entities may be able to visually ascertain whether the IP assets are likely to be easily sold in the event of the IP owner defaulting on the loan.

The communications component 130 of the analysis platform 102 may be configured to generate and/or send communications between the entities at issue, such as by utilizing the IP terminal 122. The communications may be utilized to facilitate procurement of the loan from the lender 106 to the borrower 104, to facilitate procurement of the insurance policy from the insurer 108 to the lender 106, and/or to facilitate the rating agency 110 providing a rating to the insurer 108, the lender 106, and/or the borrower 104, for example. The communications component 130 may be configured to send data to and/or receive data from the one or more devices associated with the entities in a secure manner, such as by utilizing encryption schemes, blockchain-related techniques, and/or secure user interfaces 124 where access to the user interfaces 124 is restricted and access control credentials are to be received prior to a user being able to utilize the secure user interfaces 124.

Using the example above, the communications component 130 may be configured to send the IP assessment data and/or IP asset data from the analysis platform 102 to a device associated with the lender 106. The lender 106 may utilize the IP assessment data and/or the IP asset data to make a determination as to whether the lender 106 will provide a loan to the borrower 104, and on what terms. As described in more detail below, the terms component 134 of the analysis platform 102 may be utilized to determine and/or recommend certain terms associated with the loan. The communications component 130 may also be configured to send the IP assessment data and/or the IP asset data from the analysis platform 102 to a device associated with the insurer 108. The insurer 108 may utilize the IP assessment data and/or the IP asset data to make a determination as to whether the insurer 108 will provide an insurance policy to the lender 106, and on what terms. The communications component 130 may also be configured to send details associated with the loan and/or potential loan from the lender 106 to the insurer 108. Additionally, the communications component 130 may be configured to send the IP assessment data, the IP asset data, the loan data, and/or the policy data to a device associated with the rating agency 110. The rating agency 110 may utilize this data to determine a rating to attribute to the loan and/or the insurance policy.

The monitoring component 132 of the analysis platform 102 may be configured to monitor certain aspects of the IP assets and/or the IP owner over the term of the loan. For example, securitization of the loan utilizing the IP assets may be based on the IP valuation attributable to the IP assets. As such, it may be advantageous to ensure that the IP valuation of the IP assets does not decrease over the term of the loan and/or does not decrease below at least a threshold amount. As such, the monitoring component 132 may be configured to periodically or otherwise collect updated IP asset data during the term of the loan and generate updated IP assessment data for the purpose of generating an updated IP valuation for the IP assets. The monitoring component 132 may generate the updated IP valuation and may compare that updated IP valuation to the original IP valuation associated with procurement of the loan. The monitoring component 132 may determine whether the updated IP valuation has remained constant with the original IP valuation and/or if a change has occurred. In examples where the change indicates a decrease in the IP valuation, such as by at least a threshold amount, a notification associated with the determination may be generated and sent to one or more of the entities. In examples where the updated IP valuation indicates the IP valuation has been maintained, an indication of this determination may be generated and may be made available to the entities, such as utilizing the IP terminal 122. Additional monitoring performed by the monitoring component 132 may include monitoring data associated with the IP owner, monitoring competitors of the IP owner, monitoring potential purchasers of the IP assets in the event of default, etc.

The rating component 128 of the analysis platform 102 may be configured to perform the ratings described herein. In some examples, the rating agency 110 may perform the rating. However, in other examples, the analysis platform 102 itself may perform the rating and/or may perform a rating in addition to a rating provided by the rating agency 110. When the analysis platform 102 performs the rating, the analysis platform may utilize, as input, the IP assessment data, the IP asset data, the loan data, and/or the policy data to determine a rating. In examples, other data such as details about the lender 106, the insurer 108, and/or the IP owner 104 may be utilized to make the rating. The rating may represent a score and/or grade, with a more positive score and/or grade indicating that the attributes of the loan and/or insurance policy are unlikely to result in default by the borrower 104 and/or are unlikely to result in the realization of risk by the entities involved. By contrast, a less positive score and/or grade may indicate that attributes of the loan and/or insurance policy are likely to result in default and/or are likely to result in the realization of certain risks. As used herein, the rating system may be a grade system from A to F, with A being the more positive grade and F being the least positive grade. However, it should be understood that other grading systems and/or scoring systems may be utilized.

When the analysis platform 102 performs the rating, the rating may be based at least in part on an analysis indicating a coverage score, an opportunity score, and/or an exposure score. The coverage score may be based at least in part on one or more factors, such as geographic reach of the IP assets, expiration information associated with the IP assets, assignment information, number of active IP asset counts per year, breadth of IP coverage per asset and/or in a class of assets, breadth of IP coverage in particular technological areas and/or markets, IP portfolio diversity, alignment of the IP assets to products offered by the IP owner, and/or invalidity determination, for example. The opportunity score may be based at least in part on a frequency of IP-related filings and a trend of IP-related filings as well as expected portfolio growth. The exposure score may be based at least in part on current and/or past litigation associated with the IP assets and/or the IP owner, market-level litigation statistics, participation in non-practicing entity campaigns, and alignment of exposure to revenue streams of the IP owner, for example. Some or all of these factors may be weighted and aggregated to determine the rating. When the factors are weighted, and/or when one or more of the individual scores is weighted, machine learning techniques may be utilized to determine the weightings.

The terms component 134 may be configured to determine and/or recommend certain terms of the loan and/or insurance policy based at least in part on the analyses described herein. For example, the IP assessment data and/or IP asset data may be utilized to determine one or more terms of the loan, such as the loan amount, interest rates, default terms, remedy terms, etc. The IP assessment data and/or IP asset data may also be utilized to determine one or more terms of the insurance policy, such as the coverage amount, premiums to be paid, percentage of loan amount recoverable on a paid-out claim, IP asset sale requirements, etc. To determine the terms as described herein, the terms component 134 may store data associating prior IP assessment data and/or prior IP asset data with prior loans and insurance policies. Additionally, feedback data indicating details of performance of the past loans and insurance policies may be stored. This information may be utilized by the analysis platform 102 to determine loan and/or policy terms that are affected by given IP assessment data and/or IP asset data. In examples, machine learning techniques are utilized to identify these trends and/or to generate hypothetical performance results to be utilized for recommending loan and/or policy terms for subsequent deals.

As shown in FIG. 1, several of the components of the analysis platform 102 and/or the devices associated with the borrower 104, the lender 106, the insurer 108, and/or the rating agency 110 and the associated functionality of those components as described herein may be performed by one or more of the other systems and/or by the devices. Additionally, or alternatively, some or all of the components and/or functionalities associated with the devices may be performed by the analysis platform 102.

It should be noted that the exchange of data and/or information as described herein may be performed only in situations where a user has provided consent for the exchange of such information. For example, a user may be provided with the opportunity to opt in and/or opt out of data exchanges between devices and/or with the remote systems and/or for performance of the functionalities described herein. Additionally, when one of the devices is associated with a first user account and another of the devices is associated with a second user account, user consent may be obtained before performing some, any, or all of the operations and/or processes described herein.

As used herein, a processor, such as processor(s) 112, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 112 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 112 may possess its own local memory, which also may store program components, program data, and/or one or more operating systems.

The memory 116 may include volatile and nonvolatile memory, removable and non-removable media implemented in any method or technology for storage of information, such as computer-readable instructions, data structures, program component, or other data. Such memory 116 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 116 may be implemented as computer-readable storage media (“CRSM”), which may be any available physical media accessible by the processor(s) 112 to execute instructions stored on the memory 116. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 116, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Wash., USA; the Windows operating system from Microsoft Corporation of Redmond, Wash., USA; LynxOS as promulgated by Lynx Software Technologies, Inc. of San Jose, Calif.; Operating System Embedded (Enea OSE) as promulgated by ENEA AB of Sweden; and so forth.

The network interface(s) 114 may enable messages between the components and/or devices shown in system 100 and/or with one or more other remote systems, as well as other networked devices. Such network interface(s) 114 may include one or more network interface controllers (NICs) or other types of transceiver devices to send and receive messages over the network 108.

For instance, each of the network interface(s) 114 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 114 may include a wide area network (WAN) component to enable message over a wide area network.

In some instances, the analysis platform 102 may be local to an environment associated the other devices described herein. In some instances, some or all of the functionality of the analysis platform 102 may be performed by the devices. Also, while various components of the analysis platform 102 have been labeled and named in this disclosure and each component has been described as being configured to cause the processor(s) to perform certain operations, it should be understood that the described operations may be performed by some or all of the components and/or other components not specifically illustrated.

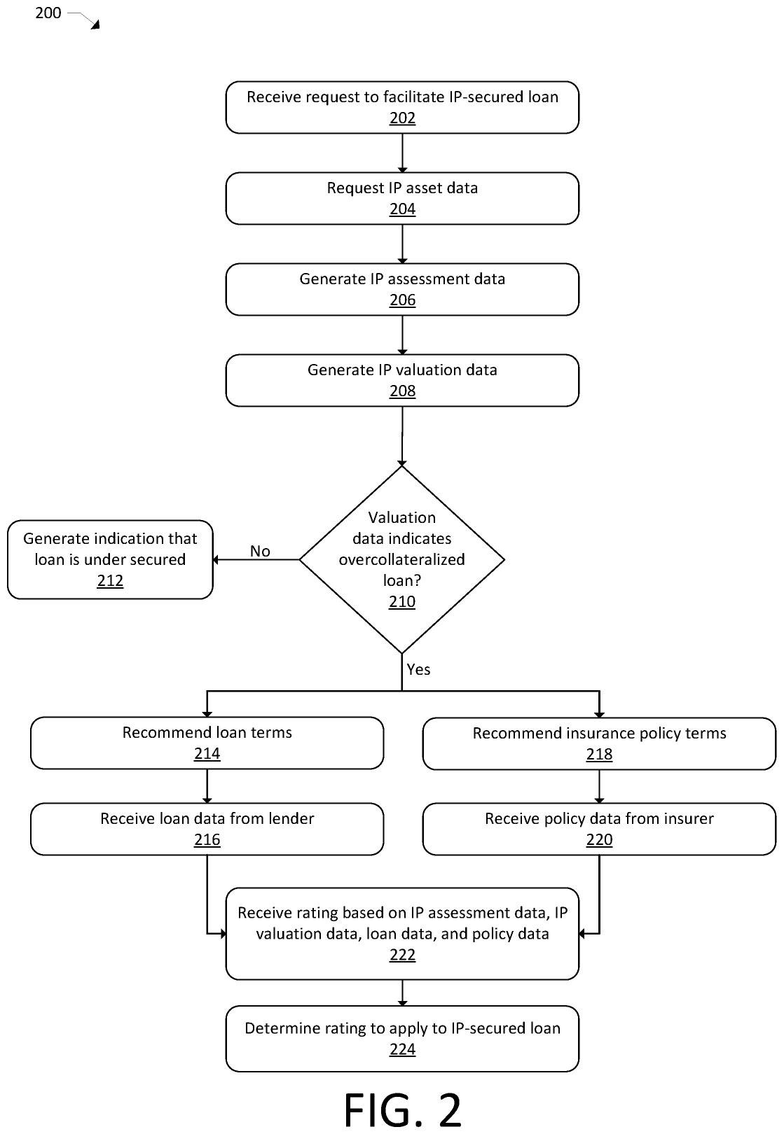

FIG. 2 illustrates processes associated with model-based analysis of IP collateral. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1 and 3-8, although the processes may be implemented in a wide variety of other environments, architectures and systems.

FIG. 2 illustrates a flow diagram of an example process 200 for determining whether valuation of IP assets is sufficient for collateralization of a loan. The order in which the operations or steps are described is not intended to be construed as a limitation, and any number of the described operations may be combined in any order and/or in parallel to implement process 200. The operations described with respect to the process 200 are described as being performed by a client device, and/or a system associated with the analysis platform. However, it should be understood that some or all of these operations may be performed by some or all of components, devices, and/or systems described herein.

At block 202, the process 200 may include receiving a request to facilitate and IP-secured loan. For example, a borrower may utilize the IP terminal described herein to securely initiate a process of acquiring a loan from a lender and utilizing IP assets of the borrower to secure the loan. In other examples, a lender may utilize the IP terminal described herein to securely initiate the process of acquiring a loan. In other examples, an insurer may utilize the IP terminal described herein to securely initiate the process of issuing an insurance policy for an IP-secured loan. In still other examples, the analysis platform described herein may recommend an IP-secured loan to the borrower and/or lender and one or more of those entities may provide user input accepting the recommendation, which may initiate the processes described herein.

At block 204, the process 200 may include requesting IP asset data. To do so, the analysis platform may generate and send a query to a device associated with a borrower requesting IP asset data. The request for IP asset data may include a request for IP asset identifiers and/or one or more identifiers of the IP owner. In other examples, the analysis system may automatically determine IP assets associated with the IP owner utilizing, in some examples, only an identifier of the IP owner and/or an identifier of one or more IP assets at issue. The analysis platform may query one or more databases, such as publicly-available IP-based databases and/or one or more registries associated with the analysis platform, for IP asset data associated with the IP assets of the borrower. In examples, one or more specific requests for IP asset data may be provided via the IP terminal. The one or more specific requests may be based on output of a trained machine learning model configured to analyze prior IP assessments and corresponding loan and/or policy terms to determine what information has impacted prior ratings. Additional details on the use of machine learning models as described here will be provided below.

At block 206, the process 200 may include generating IP assessment data. For example, an IP assessment component of the analysis platform may be configured to utilize the IP asset data to determine IP assessment data. By way of example, the IP asset data may include claims data indicating patent claims of the IP assets, specification data indicating specifications of the IP assets, figures data indicating subject matter illustrated in figures of the IP assets, file wrapper data indicating information found in a file wrapper of the IP assets, products data indicating one or more items and/or services that are offered by the IP owner, industry data indicating a technological industry in which the IP owner offers products, assignment data indicating assignment information associated with the IP assets, litigation data indicating litigation-related information associated with the IP assets, and/or other IP data as described herein. It should be understood that while several examples of IP data are provided herein, the IP data may include any data associated with IP assets of the IP owner. The IP assessment component may be configured to receive, as input, the IP asset data and to generate, as output, the IP assessment data. The IP assessment data may include any result of the analysis of the IP asset data. By way of example, the IP assessment data may include claim breadth data indicate a breadth of rights confirmed by a patent claim, a geographic reach indicating an applicability and/or strength of the IP assets in various geographic regions, assignee data indicating whether the IP assets are appropriately owned by the IP owner, timing data indicating a during of coverage of the IP assets, competitor data indicating how the IP assets compare to competitors of the IP owners, alignment data indicating how well the IP assets align with the products offered by the IP owners, validity data indicating how likely the IP assets are to be invalidated, opportunity data indicating how much opportunity the IP owner has to increase the IP portfolio and/or cover additional aspects of the technological space associated with the IP owner, exposure data indicating a likelihood that the IP assets and/or IP owner will be associated with an exposure event such as litigation, and/or other assessment data indicating an analysis of the IP assets. Additionally details on the IP assessment component are provided below.

At block 208, the process 200 may include generating IP valuation data. For example, an IP valuation component may utilize, as input, one or more of the IP assessment data and generate, as output, valuation data indicating the value of the IP assets. While additional details on the valuation of the IP assets is provided below, generally the IP valuation component may assess what a willing buyer would spend on the IP assets if sold. By way of example, an IP portfolio with many IP assets that are determined to be broad in scope, well-associated with the products offered by the IP owner, with long remaining asset terms, in diverse and/or relevant geographic regions, and without concerning issues such as assignment issues and/or litigation exposure will be valued more than an IP portfolio not having these characteristics. As part of this process, the analysis platform may identify potential purchasers of the IP assets in the event of default on a loan secured with the IP assets. These potential purchasers may be entities indicated to sell the same or similar products and/or those entities with a potential desire to expand offerings to include the products offered by the IP owner. Identification of these potential purchasers may be based at least in part on mapping data indicating aspects of the potential purchasers to the IP assets. Those potential purchasers with a mapping indicating a high degree of overlap may be considered more likely to purchase the IP assets than those will a lesser degree of overlap. Historical purchase data indicating a willingness to purchase IP assets may also be utilized when determining the potential purchasers. A probability value that a given potential purchaser will purchase the IP assets may also be provided and may also be based at least in part on the mapping. A user interface of the IP terminal may be generated that displays indicators of the potential purchasers and/or the probability values. The indicators may be presented in a ranked order such that one or more of the entities may be able to visually ascertain whether the IP assets are likely to be easily sold in the event of the IP owner defaulting on the loan.

At block 210, the process 200 may include determining whether the IP valuation data indicates overcollateralization of the loan amount for the loan. For example, loan data indicating a requested loan amount may be compared to the IP valuation to determine whether the IP valuation is greater than the requested loan amount, and in examples by how much.

In examples where the IP valuation data does not indicate overcollateralization, then the process 200 may include, at block 212, generating an indication that the loan is under secured. This indication may be sent to the lender and/or the insurer and/or the borrower and one or more of these entities may augment the data associated with the loan and/or insurance policy. For example, the lender may decrease the loan amount until the IP assets overcollateralize the loan amount. The insurer may decrease the insurance payout amount and/or increase the premium amount. The borrower may provide additional details that may affect the value of the IP assets.

In examples where the IP valuation data indicates overcollateralization, then the process 200 may include, at block 214, recommending one or more loan terms. For example, a terms component may be configured to determine and/or recommend certain terms of the loan and/or insurance policy based at least in part on the analyses described herein. For example, the IP assessment data and/or IP asset data may be utilized to determine one or more terms of the loan, such as the loan amount, interest rates, default terms, remedy terms, etc. The IP assessment data and/or IP asset data may also be utilized to determine one or more terms of the insurance policy, such as the coverage amount, premiums to be paid, percentage of loan amount recoverable on a paid-out claim, IP asset sale requirements, etc. To determine the terms as described herein, the terms component may store data associating prior IP assessment data and/or prior IP asset data with prior loans and insurance policies. Additionally, feedback data indicating details of performance of the past loans and insurance policies may be stored. This information may be utilized by the analysis platform to determine loan and/or policy terms that are affected by given IP assessment data and/or IP asset data. In examples, machine learning techniques are utilized to identify these trends and/or to generate hypothetical performance results to be utilized for recommending loan and/or policy terms for subsequent deals.

At block 216, the process 200 may include receiving loan data from the lender. For example, data associated with the loan as accepted between the borrower and lender may be provided to the IP terminal. This loan data may include details about the borrower, the lender, and/or the terms of the loan.

At block 218, the process 200 may include recommending insurance policy terms. Recommendation of the insurance policy terms may be performed in the same or a similar manner as described above with respect to block 214.

At block 220, the process 200 may include receiving policy data from the insurer. For example, data associated with the insurance policy as accepted between the lender and the insurer may be provided to the IP terminal. This policy data may include details about the lender, the insurer, and/or the terms of the insurance policy.

At block 222, the process 200 may include receiving a rating based on the IP assessment data, the IP valuation data, the loan data, and/or the policy data. In some examples, request data may be generated and may be formatted and secured such that the data associated with the request is viewable by the rating agency and not other entities. The request data may be formatted and/or ordered based at least in part on data types required by the rating agency. In other examples, the system may generate the indication of whether the loan is over or under secured by the IP assets and may provide that indication, along with any other information associated with the potential loan, to the lender. The lender may then communicate with the rating agency to establish a rating for the loan.

At block 224, the process 200 may include determining the rating to apply to the IP-secured loan. For example, a rating component of the analysis platform may be configured to perform the ratings described herein. In some examples, the rating agency may perform the rating. However, in other examples, the analysis platform itself may perform the rating and/or may perform a rating in addition to a rating provided by the rating agency. When the analysis platform performs the rating, the analysis platform may utilize, as input, the IP assessment data, the IP asset data, the loan data, and/or the policy data to determine a rating. In examples, other data such as details about the lender, the insurer, and/or the IP owner may be utilized to make the rating. The rating may represent a score and/or grade, with a more positive score and/or grade indicating that the attributes of the loan and/or insurance policy are unlikely to result in default by the borrower and/or are unlikely to result in the realization of risk by the entities involved. By contrast, a less positive score and/or grade may indicate that attributes of the loan and/or insurance policy are likely to result in default and/or are likely to result in the realization of certain risks. As used herein, the rating system may be a grade system from A to F, with A being the more positive grade and F being the least positive grade. However, it should be understood that other grading systems and/or scoring systems may be utilized.

When the analysis platform performs the rating, the rating may be based at least in part on an analysis indicating a coverage score, an opportunity score, and/or an exposure score. The coverage score may be based at least in part on one or more factors, such as geographic reach of the IP assets, expiration information associated with the IP assets, assignment information, number of active IP asset counts per year, breadth of IP coverage per asset and/or in a class of assets, breadth of IP coverage in particular technological areas and/or markets, IP portfolio diversity, alignment of the IP assets to products offered by the IP owner, and/or invalidity determination, for example. The opportunity score may be based at least in part on a frequency of IP-related filings and a trend of IP-related filings as well as expected portfolio growth. The exposure score may be based at least in part on current and/or past litigation associated with the IP assets and/or the IP owner, market-level litigation statistics, participation in non-practicing entity campaigns, and alignment of exposure to revenue streams of the IP owner, for example. Some or all of these factors may be weighted and aggregated to determine the rating. When the factors are weighted, and/or when one or more of the individual scores is weighted, machine learning techniques may be utilized to determine the weightings.

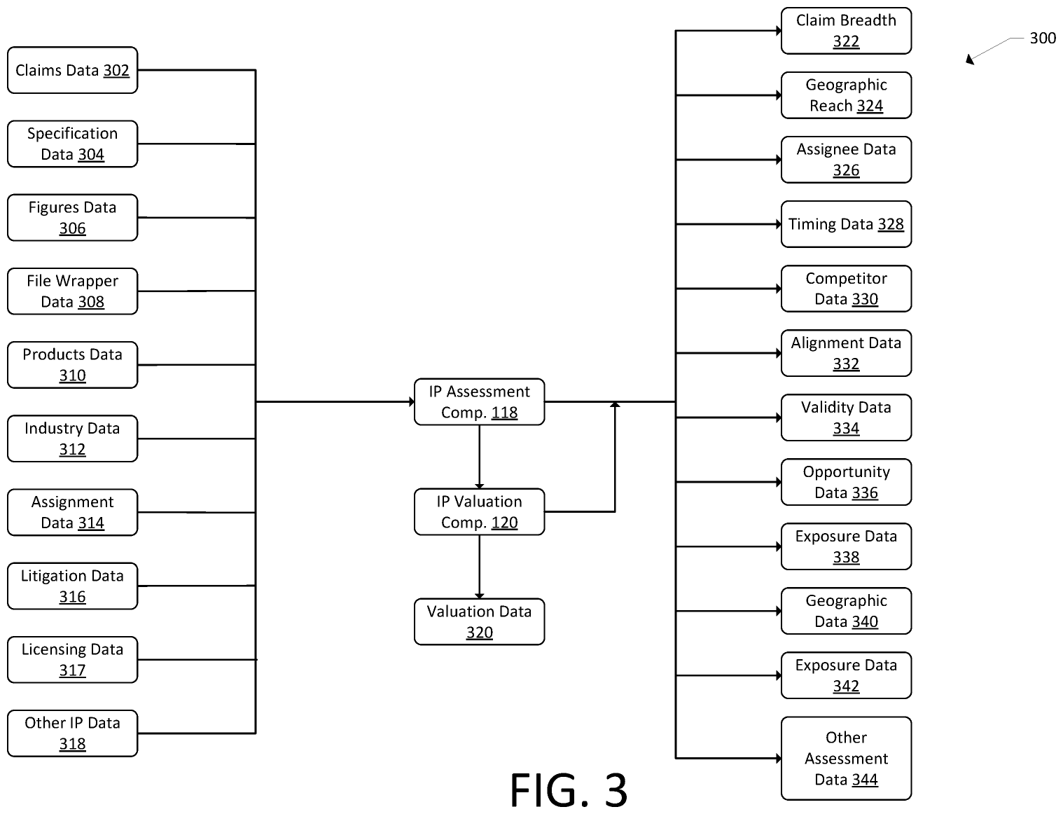

FIG. 3 illustrates a conceptual diagram 300 of example IP data and resulting IP assessment data. FIG. 3 may include some of the components described with respect to FIG. 1. For example, FIG. 3 may include an IP assessment component 118 and/or an IP valuation component 120. Additionally, FIG. 3 illustrates example IP asset data and example IP assessment data as generated by the IP assessment component 118. Furthermore, FIG. 3 illustrates example IP valuation data 320 as generated by the IP valuation component 120.

Utilizing FIG. 3 as an example, once a borrower and/or lender have initiated the process of determining whether an IP-secured loan will be issued, the analysis platform may request IP asset data. The requested IP asset data may be based at least in part on the types of IP assets at issue, the IP owner at issue, the lender at issue, and/or the results of predictive analytics indicating what IP asset data will be beneficial for valuing the IP assets and/or for providing a rating for the IP-secured loan.

Example IP asset data may include claims data 302 indicating patent claims of the IP assets, specification data 304 indicating specifications of the IP assets, figures data 306 indicating subject matter illustrated in figures of the IP assets, file wrapper data 308 indicating information found in a file wrapper of the IP assets, products data 310 indicating one or more items and/or services that are offered by the IP owner, industry data 312 indicating a technological industry in which the IP owner offers products, assignment data 314 indicating assignment information associated with the IP assets, litigation data 316 indicating litigation-related information associated with the IP assets, licensing data 317 indicating entities that are involved in licensing arrangements associated with the IP assets and/or terms of such licensing arrangements, and/or other IP data 318 as described herein. It should be understood that while several examples of IP data are provided herein, the IP data may include any data associated with IP assets of the IP owner.

The IP assessment component 118 may be configured to receive, as input, the IP asset data and to generate, as output, the IP assessment data. The IP assessment data may include any result of the analysis of the IP asset data. By way of example, the IP assessment data may include claim breadth data 322 indicating a breadth of rights confirmed by a patent claim, a geographic reach 324 indicating an applicability and/or strength of the IP assets in various geographic regions, assignee 326 data indicating whether the IP assets are appropriately owned by the IP owner, timing data 328 indicating a during of coverage of the IP assets, competitor data 330 indicating how the IP assets compare to competitors of the IP owners, alignment data 332 indicating how well the IP assets align with the products offered by the IP owners, validity data 334 indicating how likely the IP assets are to be invalidated, opportunity data 336 indicating how much opportunity the IP owner has to increase the IP portfolio and/or cover additional aspects of the technological space associated with the IP owner, exposure data 338 indicating a likelihood that the IP assets and/or IP owner will be associated with an exposure event such as litigation, geographic data 340 indicating geographic areas associated with the IP assets, exposure data 342 indicating one or more exposure metrics associated with the vulnerability of the IP assets and/or the borrower, and/or other assessment data 344 indicating an analysis of the IP assets. Additionally details on the IP assessment component are provided below.

Thereafter, the IP valuation component 120 may be utilized to determine a value of the IP assets. For example, the IP valuation component 120 may utilize, as input, one or more of the IP assessment data and generate, as output, valuation data 320 indicating the value of the IP assets. Generally the IP valuation component 120 may assess what a willing buyer would spend on the IP assets if sold. By way of example, an IP portfolio with many IP assets that are determined to be broad in scope, well-associated with the products offered by the IP owner, with long remaining asset terms, in diverse and/or relevant geographic regions, and without concerning issues such as assignment issues and/or litigation exposure will be valued more than an IP portfolio not having these characteristics. As part of this process, the analysis platform may identify potential purchasers of the IP assets in the event of default on a loan secured with the IP assets. These potential purchasers may be entities indicated to sell the same or similar products and/or those entities with a potential desire to expand offerings to include the products offered by the IP owner. Identification of these potential purchasers may be based at least in part on mapping data indicating aspects of the potential purchasers to the IP assets. Those potential purchasers with a mapping indicating a high degree of overlap may be considered more likely to purchase the IP assets than those will a lesser degree of overlap. Historical purchase data indicating a willingness to purchase IP assets may also be utilized when determining the potential purchasers. A probability value that a given potential purchaser will purchase the IP assets may also be provided and may also be based at least in part on the mapping. A user interface of the IP terminal may be generated that displays indicators of the potential purchasers and/or the probability values. The indicators may be presented in a ranked order such that one or more of the entities may be able to visually ascertain whether the IP assets are likely to be easily sold in the event of the IP owner defaulting on the loan. In examples, the valuation data from the valuation component 120 may be utilized to determine the IP assessment data outlined above.

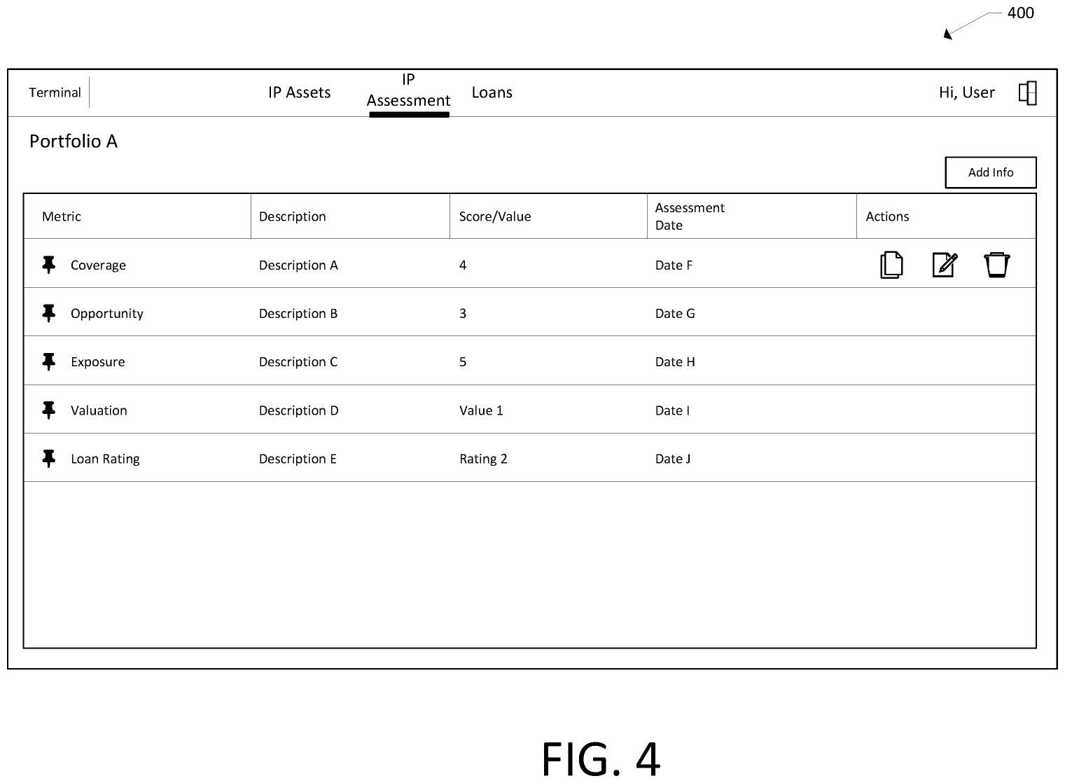

FIG. 4 illustrates a conceptual diagram of an example user interface 400 for requesting IP data and displaying IP assessment data, loan data, insurance policy data, and/or rating data. For example, the analysis platform may include a terminal where communications between devices associated with the various entities may be performed securely and with both ease of use and speed. This IP terminal may include one or more user interfaces that may be utilized by the various entities in question. For example, a potential borrower may access the IP terminal utilizing access credentials that, when entered, may display user interfaces associated with an IP owner. The user interfaces may enable the IP owner to provide details about the IP owner itself, identify IP assets associated with the IP owner, and/or to provide other information, such as information requested in association with acquiring a loan. A lender may also access the IP terminal utilizing access credentials that, when entered, may display user interfaces associated with a lender. The user interfaces may enable the lender to see IP-secured loans that the lender is associated with, see loan applications that are still in process, view data associated with IP assets used as collateral, communicate with borrowers and/or insurers, etc. An insurer may also access the IP terminal utilizing access credentials that, when entered, may display user interfaces associated with an insurer. The user interfaces may enable the insurer to see insurance policies issued to lenders, see policy applications that are still in process, view data associated with IP assets associated with secured loans, communicate with lenders, etc. A rating agency may also access the IP terminal utilizing access credentials that, when entered, may display user interfaces associated with a rating agency. The user interfaces may enable the rating agency to see loans that have been rated, view requests for ratings, view data associated with IP assets associated with secured loans and/or rated loans, communicate with lenders and/or insurers, etc. In general, the IP terminal may be utilized to request targeted, sometimes on the fly data, from relevant entities and to view data associated with IP-secured loans and related insurance policies.

Given the sensitive nature of the data at issue, the IP terminal may be configured to secure the transfer and/or storage of the IP asset data, IP assessment data, loan data, policy data, and/or rating data, as described more fully below. To do so, in addition to access controls such as password-secured logins, the IP terminal may encrypt and decrypt the various data described herein such that only devices registered to the appropriate entities are enabled to view and/or send the data.

Using FIG. 4 as an example, the user interface 400 may include one or more options for displaying IP asset data, IP assessment data, and/or loan data. The IP asset data may include indicators of IP assets associated with a given IP owner as well as, in examples, valuations associated with the individual IP assets. The IP assessment data may include one or more IP assessments performed on some or all of the IP assets.

For example, as shown in FIG. 4, given metrics associated with IP assessments may be displayed. One such metric may be “coverage,” which may be based at least in part on a coverage score associated with the IP owner. The coverage score may be based at least in part on one or more factors, such as geographic reach of the IP assets, expiration information associated with the IP assets, assignment information, number of active IP asset counts per year, breadth of IP coverage per asset and/or in a class of assets, breadth of IP coverage in particular technological areas and/or markets, IP portfolio diversity, alignment of the IP assets to products offered by the IP owner, and/or invalidity determination, for example. Additionally, a description of the metric for easy reference by a user may be provided as well as the score and/or value associated with the metric. In FIG. 4, the “coverage” metric for the IP owner in question has an associated score of “4,” which may be on a scale from 1 to 5 in examples. Additionally, an indication of when the assessment was performed may be provided. Here the “coverage” assessment was performed on “Date F.”

Additional metrics may be any result from the IP assessment, the IP valuation, and/or the rating. For example, in FIG. 4, another displayed metric is “opportunity.” The opportunity score may be based at least in part on a frequency of IP-related filings and a trend of IP-related filings as well as expected portfolio growth. Another example metric is “exposure.” The exposure score may be based at least in part on current and/or past litigation associated with the IP assets and/or the IP owner, market-level litigation statistics, participation in non-practicing entity campaigns, and alignment of exposure to revenue streams of the IP owner, for example. Some or all of these factors may be weighted and aggregated to determine the rating. When the factors are weighted, and/or when one or more of the individual scores is weighted, machine learning techniques may be utilized to determine the weightings.

Another metric is “valuation.” For example, an IP valuation component may utilize, as input, one or more of the IP assessment data and generate, as output, valuation data indicating the value of the IP assets. While additional details on the valuation of the IP assets is provided below, generally the IP valuation component may assess what a willing buyer would spend on the IP assets if sold. By way of example, an IP portfolio with many IP assets that are determined to be broad in scope, well-associated with the products offered by the IP owner, with long remaining asset terms, in diverse and/or relevant geographic regions, and without concerning issues such as assignment issues and/or litigation exposure will be valued more than an IP portfolio not having these characteristics. As part of this process, the analysis platform may identify potential purchasers of the IP assets in the event of default on a loan secured with the IP assets. These potential purchasers may be entities indicated to sell the same or similar products and/or those entities with a potential desire to expand offerings to include the products offered by the IP owner. Identification of these potential purchasers may be based at least in part on mapping data indicating aspects of the potential purchasers to the IP assets. Those potential purchasers with a mapping indicating a high degree of overlap may be considered more likely to purchase the IP assets than those will a lesser degree of overlap. Historical purchase data indicating a willingness to purchase IP assets may also be utilized when determining the potential purchasers. A probability value that a given potential purchaser will purchase the IP assets may also be provided and may also be based at least in part on the mapping. A user interface of the IP terminal may be generated that displays indicators of the potential purchasers and/or the probability values. The indicators may be presented in a ranked order such that one or more of the entities may be able to visually ascertain whether the IP assets are likely to be easily sold in the event of the IP owner defaulting on the loan.

Yet another metric is “Loan Rating.” In some examples, the rating agency may perform the rating. However, in other examples, the analysis platform itself may perform the rating and/or may perform a rating in addition to a rating provided by the rating agency. When the analysis platform performs the rating, the analysis platform may utilize, as input, the IP assessment data, the IP asset data, the loan data, and/or the policy data to determine a rating. In examples, other data such as details about the lender, the insurer, and/or the IP owner may be utilized to make the rating. The rating may represent a score and/or grade, with a more positive score and/or grade indicating that the attributes of the loan and/or insurance policy are unlikely to result in default by the borrower and/or are unlikely to result in the realization of risk by the entities involved. By contrast, a less positive score and/or grade may indicate that attributes of the loan and/or insurance policy are likely to result in default and/or are likely to result in the realization of certain risks. As used herein, the rating system may be a grade system from A to F, with A being the more positive grade and F being the least positive grade. However, it should be understood that other grading systems and/or scoring systems may be utilized.

When the analysis platform performs the rating, the rating may be based at least in part on an analysis indicating a coverage score, an opportunity score, and/or an exposure score. The coverage score may be based at least in part on one or more factors, such as geographic reach of the IP assets, expiration information associated with the IP assets, assignment information, number of active IP asset counts per year, breadth of IP coverage per asset and/or in a class of assets, breadth of IP coverage in particular technological areas and/or markets, IP portfolio diversity, alignment of the IP assets to products offered by the IP owner, and/or invalidity determination, for example. The opportunity score may be based at least in part on a frequency of IP-related filings and a trend of IP-related filings as well as expected portfolio growth. The exposure score may be based at least in part on current and/or past litigation associated with the IP assets and/or the IP owner, market-level litigation statistics, participation in non-practicing entity campaigns, and alignment of exposure to revenue streams of the IP owner, for example. Some or all of these factors may be weighted and aggregated to determine the rating. When the factors are weighted, and/or when one or more of the individual scores is weighted, machine learning techniques may be utilized to determine the weightings.

In some examples, in addition to the user interface 400 described above, the user interface 400 and/or another user interface, particularly one associated with a lender, may include a listing of loans and/or loan applications associated with the lender. The user interface may be configured to display an indicator of each of the loans and/or loan applications, and the indicators may be selected such that, when selected, additional information associated with the loans and/or loan applications are displayed using the user interface.

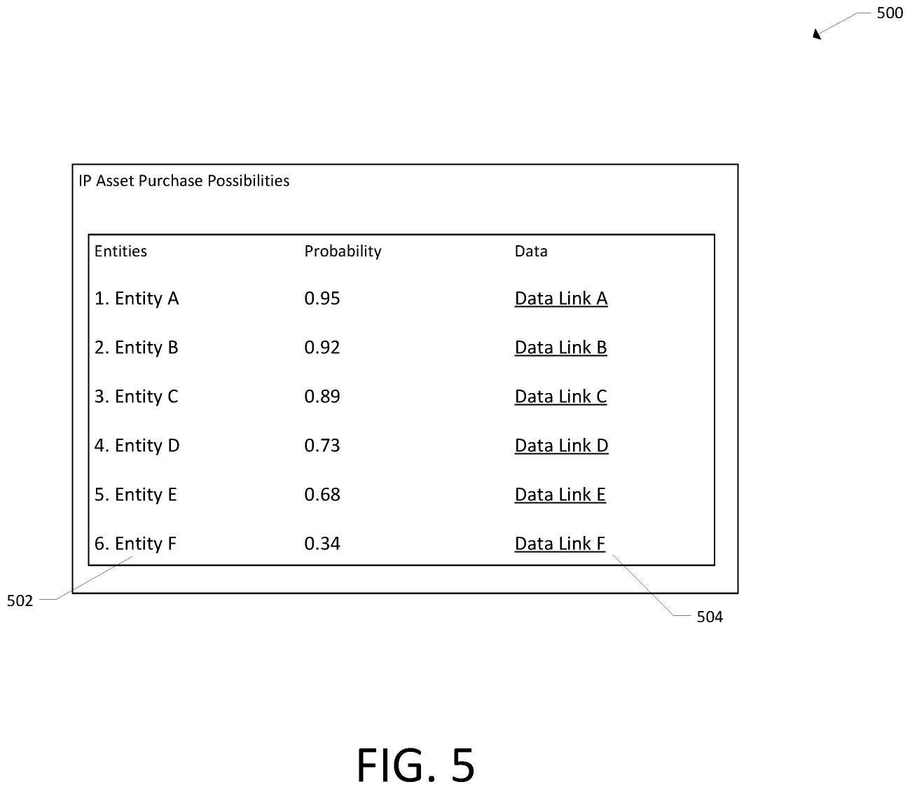

FIG. 5 illustrates a conceptual diagram of an example user interface 500 displaying results of an analysis for identifying potential purchasers of IP assets in the event of default by the IP owner.

For example, as part of the due diligence processes for rating an IP-secured loan, the analysis platform described herein may identify potential purchasers of the IP assets in the event of default on a loan secured with the IP assets. These potential purchasers may be entities indicated to sell the same or similar products and/or those entities with a potential desire to expand offerings to include the products offered by the IP owner. Identification of these potential purchasers may be based at least in part on mapping data indicating aspects of the potential purchasers to the IP assets. Those potential purchasers with a mapping indicating a high degree of overlap may be considered more likely to purchase the IP assets than those will a lesser degree of overlap. Historical purchase data indicating a willingness to purchase IP assets may also be utilized when determining the potential purchasers. A probability value that a given potential purchaser will purchase the IP assets may also be provided and may also be based at least in part on the mapping. The user interface 500 may be generated that displays indicators of the potential purchasers and/or the probability values. The indicators may be presented in a ranked order such that one or more of the entities may be able to visually ascertain whether the IP assets are likely to be easily sold in the event of the IP owner defaulting on the loan.

Utilizing FIG. 5 as an example, a list of entities 502 may be displayed on the user interface 500. The entities 502 may be ranked based on the probability value that the entities 502 would purchase the IP assets. As shown in FIG. 5, Entities A-F have been mapped to the IP assets of a given IP owner. The probability values associated with those entities purchasing the IP assets ranges from 0.95 to 0.34, on a scale of 1 to 0 with 1 being certain to purchase the IP assets and 0 being certain to not purchase the IP assets. Additionally, a data link 504 for the entities 502 may be provided. The data link 504, when selected, may cause display of the data on which the probability values were determined from. As described above, the list of entities 502 may change dynamically over time, such as in response to changes in the IP assets, changes associated with the IP owner, changes associated with a market and/or technological category of the IP owner, and/or changes associated with the entities 502.

The data utilized to provide the user interface 500 may also be utilized by the system to determine where potential gaps in the IP assets are with respect to making the portfolio of IP assets likely to be purchased by one or more of the potential purchasers. For example, to determine the potential purchasers and/or the likelihood that these potential purchasers would purchase the IP assets in the event of default, the models may identify similarities between the IP assets and IP assets and/or product offerings of the potential purchasers. Dissimilarities in this analysis may be identified and may be utilized to determine the gaps in the borrower's IP asset portfolio.

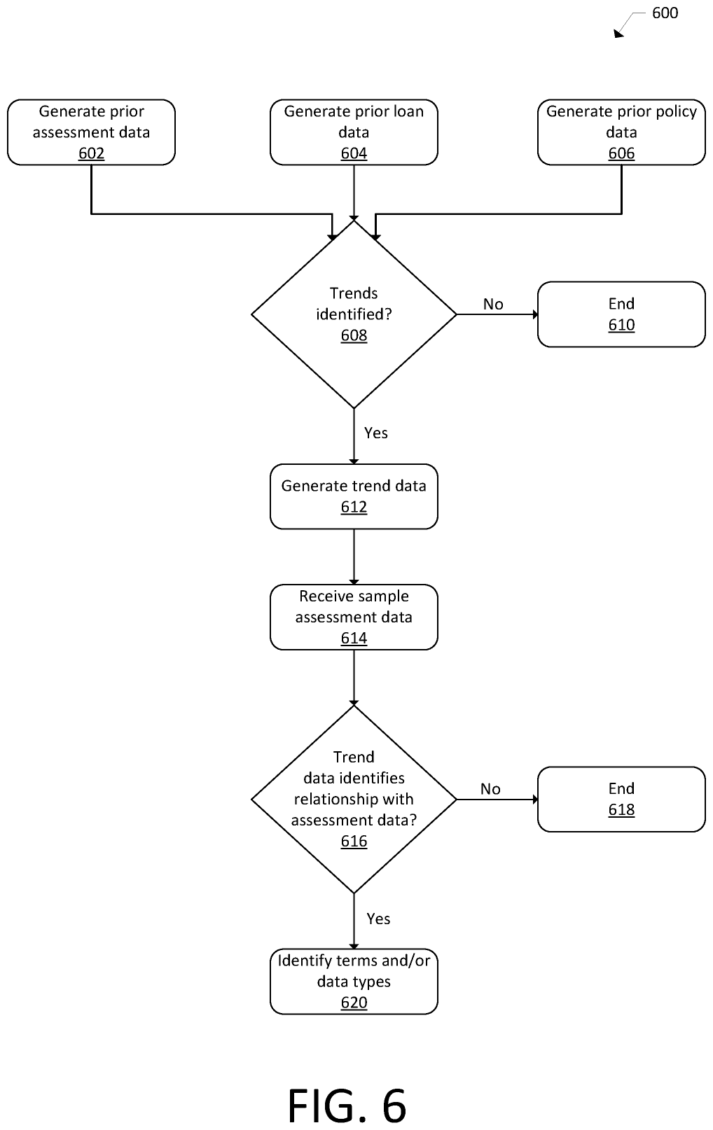

FIGS. 6-8 illustrate processes associated with model-based analysis of IP collateral. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-5, although the processes may be implemented in a wide variety of other environments, architectures and systems.

FIG. 6 illustrates a flow diagram of an example process 600 for identifying trends associated with model-based analysis of IP collateral. The order in which the operations or steps are described is not intended to be construed as a limitation, and any number of the described operations may be combined in any order and/or in parallel to implement process 600. The operations described with respect to the process 600 are described as being performed by a client device, and/or a system associated with the analysis platform. However, it should be understood that some or all of these operations may be performed by some or all of components, devices, and/or systems described herein.

At block 602, the process 600 may include generating prior assessment data. For example, an IP assessment component of the analysis platform may be configured to utilize prior IP asset data to determine prior IP assessment data. By way of example, the IP asset data may include claims data indicating patent claims of the IP assets, specification data indicating specifications of the IP assets, figures data indicating subject matter illustrated in figures of the IP assets, file wrapper data indicating information found in a file wrapper of the IP assets, products data indicating one or more items and/or services that are offered by the IP owner, industry data indicating a technological industry in which the IP owner offers products, assignment data indicating assignment information associated with the IP assets, litigation data indicating litigation-related information associated with the IP assets, and/or other IP data as described herein. It should be understood that while several examples of IP data are provided herein, the IP data may include any data associated with IP assets of the IP owner. The IP assessment component may be configured to receive, as input, the IP asset data and to generate, as output, the IP assessment data. The IP assessment data may include any result of the analysis of the IP asset data. By way of example, the IP assessment data may include claim breadth data indicate a breadth of rights confirmed by a patent claim, a geographic reach indicating an applicability and/or strength of the IP assets in various geographic regions, assignee data indicating whether the IP assets are appropriately owned by the IP owner, timing data indicating a during of coverage of the IP assets, competitor data indicating how the IP assets compare to competitors of the IP owners, alignment data indicating how well the IP assets align with the products offered by the IP owners, validity data indicating how likely the IP assets are to be invalidated, opportunity data indicating how much opportunity the IP owner has to increase the IP portfolio and/or cover additional aspects of the technological space associated with the IP owner, exposure data indicating a likelihood that the IP assets and/or IP owner will be associated with an exposure event such as litigation, and/or other assessment data indicating an analysis of the IP assets. Additionally details on the IP assessment component are provided below.

At block 604, the process 600 may include generating prior loan data. For example, when loans are provided in association with analysis of the prior assessment data, loan data indicating details about the loans, including terms of the loans, may be generated and stored.

At block 606, the process 600 may include generating prior policy data. For example, when insurance policies are provided in association with analysis of the prior assessment data, policy data indicating details about the policies, including terms of the policies, may be generated and stored.

At block 608, the process 600 may include determining whether one or more trends as between the prior assessment data and at least one of the prior loan data or the prior policy data have been identified. Determining the one or more trends may be based at least in part on predictive analytics that identifies when certain IP assessment data is at least a contributing factor to IP valuation and/or determinations to offer loans and/or insurance policies. The predictive analytics may include the use of trained machine learning models configured to identify the trends.

For example, the machine learning models as described herein may include predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

Information from stored and/or accessible data may be extracted from one or more databases and may be utilized to predict trends and behavior patterns. In examples, the event, otherwise described herein as an outcome, may be an event that will occur in the future, such as whether presence will be detected. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome. Then, data may be collected and/or accessed to be used for analysis.

Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. Thereafter, predictive modelling may be performed to generate accurate predictive models for future events. Outcome prediction may be deterministic such that the outcome is determined to occur or not occur. Additionally, or alternatively, the outcome prediction may be probabilistic such that the outcome is determined to occur to a certain probability and/or confidence.

As described herein, the machine learning models may be configured to be trained utilizing a training dataset associated with the IP assessment data, loan data, policy data, and/or rating data. The models may be trained for multiple user accounts and/or for a specific user account. As such, the machine learning models may be configured to learn, without human intervention, attributes of IP asset data, IP assessment data, and/or IP valuation data that are more likely and/or less likely to be associated with issuance of loans, insurance policies, and/or favorable ratings.

In instances where no trends are identified, the process 600 may end at block 610. In these examples, trends have not been identified, and/or have not been identified to at least a threshold degree of confidence to associate given prior assessment data with given loan terms and/or or policy terms. As such, additional assessment data, loan data, and/or policy data is to be collected and analyzed before a trend is identified.

In instances where at least one trend is identified, the process 600 may include, at block 612, generating trend data associated with the trend. The trend data may associate the IP assessment data with an indication of the effect that IP assessment data has on obtaining loans, insurance policies, and/or favorable ratings.

At block 614, the process 600 may include receiving sample assessment data. The sample assessment data may be the result of the IP assessment component analyzing IP asset data for a particular IP owner looking to procure an IP-secured loan.

At block 616, the process 600 may include determining whether the trend data identifies a relationship with the sample assessment data. For example, if one or more of the trends indicates an IP assessment data type that corresponds to a data type of the sample assessment data, then the trend associated with that data type may be identified and a relationship indicated by that trend may be determined.

In instances where the trend data does not identify a relationship, then at block 618 the process 600 may end. In these examples, while one or more trends associated with prior assessment data have been identified, the sample assessment data in question is not associated with the prior assessment data. As such, trends associated with the prior assessment data may not be utilized to determine whether one or more loan terms and/or policy terms and/or requested IP data types should be utilized in association with the sample assessment data.

In instances where the trend data identifies a relationship, then the process 600 may include, at block 620, identifying one or more terms and/or data types indicated by the trend data to be associated with the sample assessment data. For example, the trend may indicate that when certain IP assessment data is present, one or more terms of prior loans and/or insurance policies have been utilized. Indicators of these terms may be generated and sent to one or more of the involved entities as a recommendation for the terms to be included in the loan and/or insurance policy that are likely to result in a favorable rating.

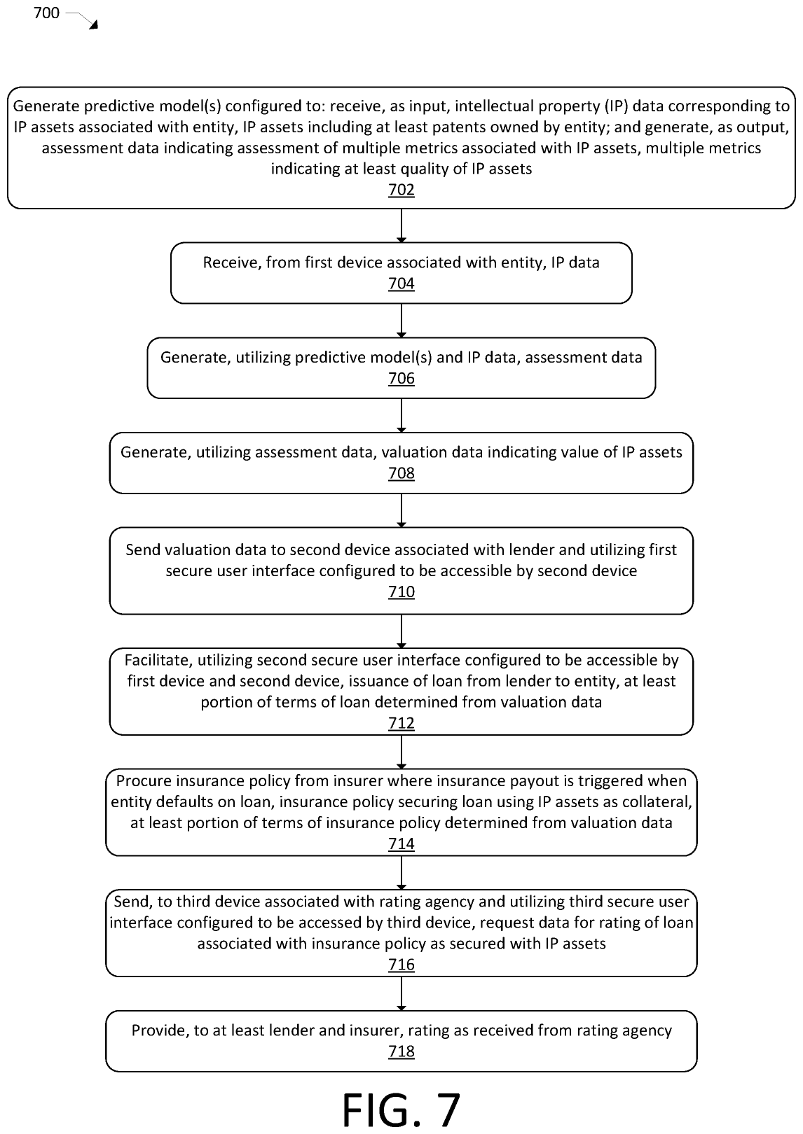

FIG. 7 illustrates a flow diagram of an example process 700 for model-based analysis of IP collateral. The order in which the operations or steps are described is not intended to be construed as a limitation, and any number of the described operations may be combined in any order and/or in parallel to implement process 700. The operations described with respect to the process 700 are described as being performed by a client device, and/or a system associated with the analysis platform. However, it should be understood that some or all of these operations may be performed by some or all of components, devices, and/or systems described herein.

At block 702, the process 700 may include generating one or more predictive models configured to: receive, as input, intellectual property (IP) data corresponding to IP assets associated with an entity, the IP assets including at least patents owned by the entity; and generate, as output, assessment data indicating an assessment of multiple metrics associated with the IP assets, the multiple metrics indicating at least a quality of the IP assets.

For example, the machine learning models as described herein may include predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

Information from stored and/or accessible data may be extracted from one or more databases and may be utilized to predict trends and behavior patterns. In examples, the event, otherwise described herein as an outcome, may be an event that will occur in the future, such as whether presence will be detected. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome. Then, data may be collected and/or accessed to be used for analysis.

Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. Thereafter, predictive modelling may be performed to generate accurate predictive models for future events. Outcome prediction may be deterministic such that the outcome is determined to occur or not occur. Additionally, or alternatively, the outcome prediction may be probabilistic such that the outcome is determined to occur to a certain probability and/or confidence.

As described herein, the machine learning models may be configured to be trained utilizing a training dataset associated with the IP assessment data, loan data, policy data, and/or rating data. The models may be trained for multiple user accounts and/or for a specific user account. As such, the machine learning models may be configured to learn, without human intervention, attributes of IP asset data, IP assessment data, and/or IP valuation data that are more likely and/or less likely to be associated with issuance of loans, insurance policies, and/or favorable ratings.

At block 704, the process 700 may include receiving, from a first device associated with the entity, the IP data. For example, an analysis platform may generate and send a query to a device associated with a borrower requesting IP asset data. The request for IP asset data may include a request for IP asset identifiers and/or one or more identifiers of the IP owner. In other examples, the analysis system may automatically determine IP assets associated with the IP owner utilizing, in some examples, only an identifier of the IP owner and/or an identifier of one or more IP assets at issue. The analysis platform may query one or more databases, such as publicly-available IP-based databases and/or one or more registries associated with the analysis platform, for IP asset data associated with the IP assets of the borrower. In examples, one or more specific requests for IP asset data may be provided via the IP terminal. The one or more specific requests may be based on output of a trained machine learning model configured to analyze prior IP assessments and corresponding loan and/or policy terms to determine what information has impacted prior ratings. Additional details on the use of machine learning models as described here will be provided below.

At block 706, the process 700 may include generating, utilizing the one or more predictive models and the IP data, the assessment data. By way of example, the IP asset data may include claims data indicating patent claims of the IP assets, specification data indicating specifications of the IP assets, figures data indicating subject matter illustrated in figures of the IP assets, file wrapper data indicating information found in a file wrapper of the IP assets, products data indicating one or more items and/or services that are offered by the IP owner, industry data indicating a technological industry in which the IP owner offers products, assignment data indicating assignment information associated with the IP assets, litigation data indicating litigation-related information associated with the IP assets, and/or other IP data as described herein. It should be understood that while several examples of IP data are provided herein, the IP data may include any data associated with IP assets of the IP owner. The IP assessment component may be configured to receive, as input, the IP asset data and to generate, as output, the IP assessment data. The IP assessment data may include any result of the analysis of the IP asset data. By way of example, the IP assessment data may include claim breadth data indicate a breadth of rights confirmed by a patent claim, a geographic reach indicating an applicability and/or strength of the IP assets in various geographic regions, assignee data indicating whether the IP assets are appropriately owned by the IP owner, timing data indicating a during of coverage of the IP assets, competitor data indicating how the IP assets compare to competitors of the IP owners, alignment data indicating how well the IP assets align with the products offered by the IP owners, validity data indicating how likely the IP assets are to be invalidated, opportunity data indicating how much opportunity the IP owner has to increase the IP portfolio and/or cover additional aspects of the technological space associated with the IP owner, exposure data indicating a likelihood that the IP assets and/or IP owner will be associated with an exposure event such as litigation, and/or other assessment data indicating an analysis of the IP assets. Additionally details on the IP assessment component are provided below.

At block 708, the process 700 may include generating, utilizing the assessment data, valuation data indicating a value of the IP assets. For example, an IP valuation component may utilize, as input, one or more of the IP assessment data and generate, as output, valuation data indicating the value of the IP assets. While additional details on the valuation of the IP assets is provided below, generally the IP valuation component may assess what a willing buyer would spend on the IP assets if sold. By way of example, an IP portfolio with many IP assets that are determined to be broad in scope, well-associated with the products offered by the IP owner, with long remaining asset terms, in diverse and/or relevant geographic regions, and without concerning issues such as assignment issues and/or litigation exposure will be valued more than an IP portfolio not having these characteristics. As part of this process, the analysis platform may identify potential purchasers of the IP assets in the event of default on a loan secured with the IP assets. These potential purchasers may be entities indicated to sell the same or similar products and/or those entities with a potential desire to expand offerings to include the products offered by the IP owner. Identification of these potential purchasers may be based at least in part on mapping data indicating aspects of the potential purchasers to the IP assets. Those potential purchasers with a mapping indicating a high degree of overlap may be considered more likely to purchase the IP assets than those will a lesser degree of overlap. Historical purchase data indicating a willingness to purchase IP assets may also be utilized when determining the potential purchasers. A probability value that a given potential purchaser will purchase the IP assets may also be provided and may also be based at least in part on the mapping. A user interface of the IP terminal may be generated that displays indicators of the potential purchasers and/or the probability values. The indicators may be presented in a ranked order such that one or more of the entities may be able to visually ascertain whether the IP assets are likely to be easily sold in the event of the IP owner defaulting on the loan.

At block 710, the process 700 may include sending the valuation data to a second device associated with a lender and utilizing a first secure user interface configured to be accessible by the second device. For example, the valuation data may be utilized by the lender to determine whether the issuance of a loan with a given loan amount will result in the loan being overcapitalized or undercapitalized by the IP assets. In other examples, the process 700 may include sending an indication that the loan is sufficiently secured by the value of the IP assets to the lender and/or one or more other entities. In these examples, a loan may be sufficiently secured when the value of the IP assets is determined to be more than the loan amount and/or a certain percentage of the loan amount.

At block 712, the process 700 may include facilitating, utilizing a second secure user interface configured to be accessible by the first device and the second device, issuance of a loan from the lender to the entity, at least a portion of the terms of the loan determined from the valuation data. For example, a communications component may be utilized to facilitate procurement of the loan from the lender to the borrower, to facilitate procurement of the insurance policy from the insurer to the lender, and/or to facilitate the rating agency providing a rating to the insurer, the lender, and/or the borrower, for example. The communications component may be configured to send data to and/or receive data from the one or more devices associated with the entities in a secure manner, such as by utilizing encryption schemes, blockchain-related techniques, and/or secure user interfaces where access to the user interfaces is restricted and access control credentials are to be received prior to a user being able to utilize the secure user interfaces.

Using the example above, the communications component may be configured to send the IP assessment data and/or IP asset data from the analysis platform to a device associated with the lender. The lender may utilize the IP assessment data and/or the IP asset data to make a determination as to whether the lender will provide a loan to the borrower, and on what terms. As described in more detail below, a terms component of the analysis platform may be utilized to determine and/or recommend certain terms associated with the loan.

At block 714, the process 700 may include procuring an insurance policy from an insurer where an insurance payout is triggered when the entity defaults on the loan, the insurance policy securing the loan using the IP assets as collateral, at least a portion of the terms of the insurance policy determined from the valuation data. For example, the communications component may also be configured to send the IP assessment data and/or the IP asset data from the analysis platform to a device associated with the insurer. The insurer may utilize the IP assessment data and/or the IP asset data to make a determination as to whether the insurer will provide an insurance policy to the lender, and on what terms.

At block 716, the process 700 may include sending, to a third device associated with a rating agency and utilizing a third secure user interface configured to be accessed by the third device, request data for a rating of the loan associated with the insurance policy as secured with the IP assets. For example, the communications component may also be configured to send details associated with the loan and/or potential loan from the lender to the insurer. Additionally, the communications component may be configured to send the IP assessment data, the IP asset data, the loan data, and/or the policy data to a device associated with the rating agency. The rating agency may utilize this data to determine a rating to attribute to the loan and/or the insurance policy.

At block 718, the process 700 may include providing, to at least the lender and the insurer, the rating as received from the rating agency. For example, the IP terminal described herein may be utilized to provide an indication of the rating. When predictive analytics are utilized, the indication may also include identifiers of factors that likely impacted the rating and suggestions on how to improve the rating, such as by changing the terms of the loan, changing the terms of the insurance policy, changing attributes associated with the IP assets, etc.

Additionally, or alternatively, the process 700 may include querying, during a term of the loan, one or more databases for updated IP data associated with the IP assets, the updated IP data indicating differences between the IP data prior to the loan and the IP data after issuance of the loan. The process 700 may also include generating, utilizing the one or more predictive models, updated assessment data and generating, utilizing the updated assessment data, updated valuation data indicating an updated value of the IP assets. The process 700 may also include determining that the updated value of the IP assets is within a threshold amount of the value of the IP assets. The process 700 may also include, in response to the updated value being within the threshold amount, causing the first secure user interface to display an indication that the value of the IP assets has been maintained.

Additionally, or alternatively, the process 700 may include determining, utilizing a trained model configured to map products and services to IP assets, one or more entities in a technology category that the IP assets are associated with. The process 700 may also include determining, utilizing historical data associated with the one or more entities, a probability value that the one or more entities would purchase the IP assets. The process 700 may also include including, in the assessment data, an indicator of the one or more entities and the probability value.

Additionally, or alternatively, the process 700 may include generating, utilizing a machine learning model, historical term data indicating associations between prior insurance policy terms and prior assessment data and storing the historical term data in a database. The process 700 may also include, in response to generating the assessment data, querying the database to determine the associations related to the assessment data. The process 700 may also include identifying, from the database, a set of the prior assessment data that corresponds to the assessment data and including, in the insurance policy, a set of the prior insurance policy terms associated with the set of the prior assessment data.

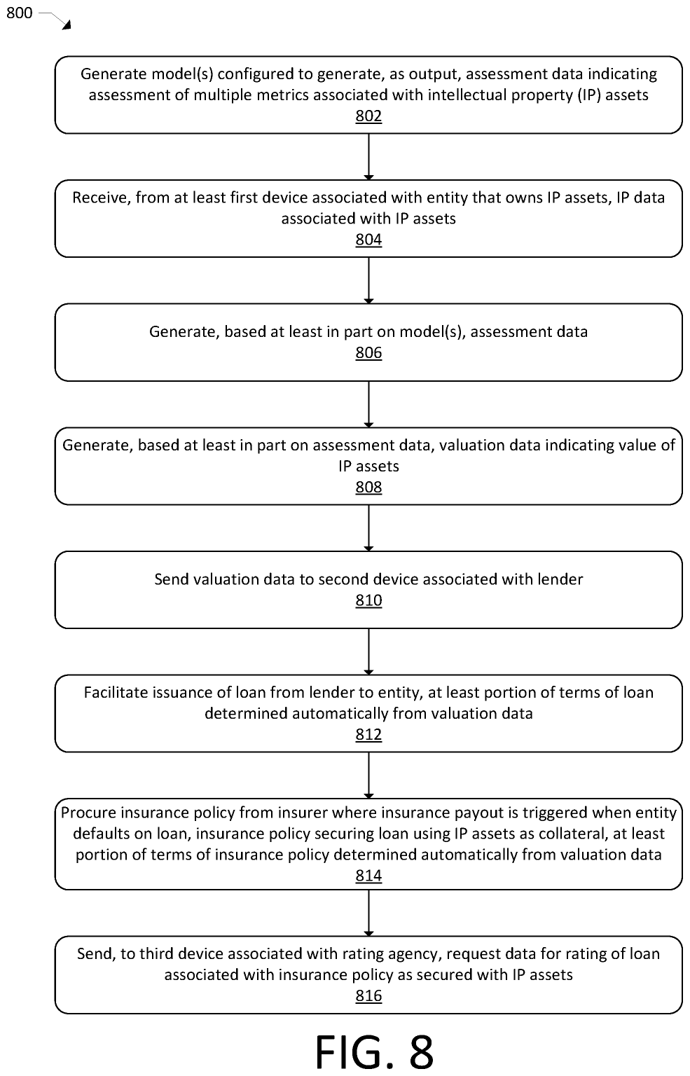

FIG. 8 illustrates a flow diagram of another example process 800 for model-based analysis of IP collateral. The order in which the operations or steps are described is not intended to be construed as a limitation, and any number of the described operations may be combined in any order and/or in parallel to implement process 800. The operations described with respect to the process 800 are described as being performed by a client device, and/or a system associated with the analysis platform. However, it should be understood that some or all of these operations may be performed by some or all of components, devices, and/or systems described herein.

At block 802, the process 800 may include generating one or more models configured to generate, as output, assessment data indicating an assessment of multiple metrics associated with intellectual property (IP) assets. For example, the machine learning models as described herein may include predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

Information from stored and/or accessible data may be extracted from one or more databases and may be utilized to predict trends and behavior patterns. In examples, the event, otherwise described herein as an outcome, may be an event that will occur in the future, such as whether presence will be detected. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome. Then, data may be collected and/or accessed to be used for analysis.

Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. Thereafter, predictive modelling may be performed to generate accurate predictive models for future events. Outcome prediction may be deterministic such that the outcome is determined to occur or not occur. Additionally, or alternatively, the outcome prediction may be probabilistic such that the outcome is determined to occur to a certain probability and/or confidence.

As described herein, the machine learning models may be configured to be trained utilizing a training dataset associated with the IP assessment data, loan data, policy data, and/or rating data. The models may be trained for multiple user accounts and/or for a specific user account. As such, the machine learning models may be configured to learn, without human intervention, attributes of IP asset data, IP assessment data, and/or IP valuation data that are more likely and/or less likely to be associated with issuance of loans, insurance policies, and/or favorable ratings.

At block 804, the process 800 may include receiving, from at least a first device associated with an entity that owns the IP assets, IP data associated with the IP assets. For example, an analysis platform may generate and send a query to a device associated with a borrower requesting IP asset data. The request for IP asset data may include a request for IP asset identifiers and/or one or more identifiers of the IP owner. In other examples, the analysis system may automatically determine IP assets associated with the IP owner utilizing, in some examples, only an identifier of the IP owner and/or an identifier of one or more IP assets at issue. The analysis platform may query one or more databases, such as publicly-available IP-based databases and/or one or more registries associated with the analysis platform, for IP asset data associated with the IP assets of the borrower. In examples, one or more specific requests for IP asset data may be provided via the IP terminal. The one or more specific requests may be based on output of a trained machine learning model configured to analyze prior IP assessments and corresponding loan and/or policy terms to determine what information has impacted prior ratings. Additional details on the use of machine learning models as described here will be provided below.

At block 806, the process 800 may include generating, based at least in part on the one or more models, the assessment data. By way of example, the IP asset data may include claims data indicating patent claims of the IP assets, specification data indicating specifications of the IP assets, figures data indicating subject matter illustrated in figures of the IP assets, file wrapper data indicating information found in a file wrapper of the IP assets, products data indicating one or more items and/or services that are offered by the IP owner, industry data indicating a technological industry in which the IP owner offers products, assignment data indicating assignment information associated with the IP assets, litigation data indicating litigation-related information associated with the IP assets, and/or other IP data as described herein. It should be understood that while several examples of IP data are provided herein, the IP data may include any data associated with IP assets of the IP owner. The IP assessment component may be configured to receive, as input, the IP asset data and to generate, as output, the IP assessment data. The IP assessment data may include any result of the analysis of the IP asset data. By way of example, the IP assessment data may include claim breadth data indicate a breadth of rights confirmed by a patent claim, a geographic reach indicating an applicability and/or strength of the IP assets in various geographic regions, assignee data indicating whether the IP assets are appropriately owned by the IP owner, timing data indicating a during of coverage of the IP assets, competitor data indicating how the IP assets compare to competitors of the IP owners, alignment data indicating how well the IP assets align with the products offered by the IP owners, validity data indicating how likely the IP assets are to be invalidated, opportunity data indicating how much opportunity the IP owner has to increase the IP portfolio and/or cover additional aspects of the technological space associated with the IP owner, exposure data indicating a likelihood that the IP assets and/or IP owner will be associated with an exposure event such as litigation, and/or other assessment data indicating an analysis of the IP assets. Additionally details on the IP assessment component are provided below.

At block 808, the process 800 may include generating, based at least in part on the assessment data, valuation data indicating a value of the IP assets. For example, an IP valuation component may utilize, as input, one or more of the IP assessment data and generate, as output, valuation data indicating the value of the IP assets. While additional details on the valuation of the IP assets is provided below, generally the IP valuation component may assess what a willing buyer would spend on the IP assets if sold. By way of example, an IP portfolio with many IP assets that are determined to be broad in scope, well-associated with the products offered by the IP owner, with long remaining asset terms, in diverse and/or relevant geographic regions, and without concerning issues such as assignment issues and/or litigation exposure will be valued more than an IP portfolio not having these characteristics. As part of this process, the analysis platform may identify potential purchasers of the IP assets in the event of default on a loan secured with the IP assets. These potential purchasers may be entities indicated to sell the same or similar products and/or those entities with a potential desire to expand offerings to include the products offered by the IP owner. Identification of these potential purchasers may be based at least in part on mapping data indicating aspects of the potential purchasers to the IP assets. Those potential purchasers with a mapping indicating a high degree of overlap may be considered more likely to purchase the IP assets than those will a lesser degree of overlap. Historical purchase data indicating a willingness to purchase IP assets may also be utilized when determining the potential purchasers. A probability value that a given potential purchaser will purchase the IP assets may also be provided and may also be based at least in part on the mapping. A user interface of the IP terminal may be generated that displays indicators of the potential purchasers and/or the probability values. The indicators may be presented in a ranked order such that one or more of the entities may be able to visually ascertain whether the IP assets are likely to be easily sold in the event of the IP owner defaulting on the loan.

At block 810, the process 800 may include sending the valuation data to a second device associated with a lender. For example, the valuation data may be utilized by the lender to determine whether the issuance of a loan with a given loan amount will result in the loan being overcapitalized or undercapitalized by the IP assets.

At block 812, the process 800 may include facilitating issuance of a loan from the lender to the entity, at least a portion of the terms of the loan determined automatically from the valuation data. For example, a communications component may be utilized to facilitate procurement of the loan from the lender to the borrower, to facilitate procurement of the insurance policy from the insurer to the lender, and/or to facilitate the rating agency providing a rating to the insurer, the lender, and/or the borrower, for example. The communications component may be configured to send data to and/or receive data from the one or more devices associated with the entities in a secure manner, such as by utilizing encryption schemes, blockchain-related techniques, and/or secure user interfaces where access to the user interfaces is restricted and access control credentials are to be received prior to a user being able to utilize the secure user interfaces.

Using the example above, the communications component may be configured to send the IP assessment data and/or IP asset data from the analysis platform to a device associated with the lender. The lender may utilize the IP assessment data and/or the IP asset data to make a determination as to whether the lender will provide a loan to the borrower, and on what terms. As described in more detail below, a terms component of the analysis platform may be utilized to determine and/or recommend certain terms associated with the loan.

At block 814, the process 800 may include procuring an insurance policy from an insurer where an insurance payout is triggered when the entity defaults on the loan, the insurance policy securing the loan using the IP assets as collateral, at least a portion of the terms of the insurance policy determined automatically from the valuation data. For example, the communications component may also be configured to send the IP assessment data and/or the IP asset data from the analysis platform to a device associated with the insurer. The insurer may utilize the IP assessment data and/or the IP asset data to make a determination as to whether the insurer will provide an insurance policy to the lender, and on what terms.

At block 816, the process 800 may include sending, to a third device associated with a rating agency, request data for a rating of the loan associated with the insurance policy as secured with the IP assets. For example, the communications component may also be configured to send details associated with the loan and/or potential loan from the lender to the insurer. Additionally, the communications component may be configured to send the IP assessment data, the IP asset data, the loan data, and/or the policy data to a device associated with the rating agency. The rating agency may utilize this data to determine a rating to attribute to the loan and/or the insurance policy.

Additionally, or alternatively, the process 800 may include querying, during a term of the loan, one or more databases for updated IP data associated with the IP assets. The process 800 may also include generating updated assessment data and generating, based at least in part on the updated assessment data, updated valuation data indicating an updated value of the IP assets. The process 800 may also include determining that the updated value of the IP assets is within a threshold amount of the value of the IP assets. The process 800 may also include, based at least in part on the updated value being within the threshold amount, generating an indication that the value of the IP assets has been maintained.

Additionally, or alternatively, the process 800 may include determining one or more entities in a technology category that the IP assets are associated with. The process 800 may also include determining, based at least in part on historical data associated with the one or more entities, a probability value that the one or more entities would purchase the IP assets. The process 800 may also include including, in the assessment data, an indicator of the one or more entities and the probability value.

Additionally, or alternatively, the process 800 may include generating historical term data indicating associations between prior insurance policy terms and prior assessment data. The process 800 may also include identifying a set of the prior assessment data that corresponds to the assessment data. The process 800 may also include including, in the insurance policy, a set of the prior insurance policy terms associated with the set of the prior assessment data.

Additionally, or alternatively, the process 800 may include generating a machine learning model configured to determine factors that impact the rating. The process 800 may also include training the machine learning model utilizing, as a training dataset, feedback data associated with prior ratings of prior loans secured using other IP assets such that a trained machine learning model is generated. The process 800 may also include determining, utilizing the trained machine learning model, a group of the factors that are likely to impact the rating associated with the loan. The process 800 may also include identifying types of assessment data associated with the group of the factors and querying the entity for the types of the assessment data.

Additionally, or alternatively, the process 800 may include determining one or more triggers events that, when determined to occur during a term of the loan, causes the system to: determine one or more entities in a technology category that the IP assets are associated with; and determine, based at least in part on historical data associated with the one or more entities, a probability value that the one or more entities would purchase the IP assets. The process 800 may also include detecting occurrence of at least one of the one or more trigger event. The process 800 may also include, in response to detecting the occurrence: determining the one or more entities in the technology category; and determining the probability value that the one or more entities will purchase the IP assets.

Additionally, or alternatively, the process 800 may include generating an IP terminal configured to selectively display information to the entity, the lender, the insurer, and the rating agency. The process 800 may also include generating, for use in association with the IP terminal, a first user interface configured to secure first data sent between the entity and the lender. The process 800 may also include generating, for use in association with the IP terminal, a second user interface configured to secure second data sent between the lender and the insurer. The process 800 may also include generating, for use in association with the IP terminal, a third user interface configured to secure third data sent between the rating agency and at least one of the lender or the insurer.

Additionally, or alternatively, the process 800 may include determining, utilizing the assessment data, a coverage score associated with the IP assets, the coverage score indicating how well the IP assets are associated with a business associated with the entity and how much of a technological area associated with the entity is covered by the IP assets. The process 800 may also include determining, utilizing the assessment data, an opportunity score associated with the IP assets, the opportunity score indicating an ability of the entity to increase coverage of the IP assets for the technological area. The process 800 may also include determining, utilizing the assessment, data, an exposure score associated with the IP assets, the exposure score indicating a likelihood of IP-related exposure to the entity. The process 800 may also include generating the rating based at least in part on the coverage score, the opportunity score, and the exposure score.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

1. A system comprising:
one or more processors; and
non-transitory computer-readable media storing instructions that, when executed by the one or more processors, cause the one or more processors to perform operations comprising:
generating one or more predictive machine learning models configured to:
receive, as input, intellectual property (IP) data corresponding to IP assets associated with an entity, the IP assets including at least patents owned by the entity; and
generate, as output, assessment data indicating an assessment of multiple metrics associated with the IP assets, the multiple metrics indicating at least a quality of the IP assets;
receiving, from a first device associated with the entity, the IP data;
generating, utilizing the one or more predictive machine learning models and the IP data, the assessment data;
generating, utilizing the assessment data, valuation data indicating a value of the IP assets;
sending, to a second device associated with a lender and utilizing a first secure user interface configured to be accessible by the second device, an indication that a loan from the lender to the entity is sufficiently secured by the value of the IP assets;
facilitating, utilizing a second secure user interface configured to be accessible by the first device and the second device, issuance of the loan from the lender to the entity, at least a portion of the terms of the loan determined from the valuation data;
procuring an insurance policy from an insurer where an insurance payout is triggered when the entity defaults on the loan, the loan secured using the IP assets as collateral, at least a portion of the terms of the insurance policy determined from the valuation data; and
receiving, from a third device associated with a rating agency and utilizing a third secure user interface configured to be accessed by the third device, a rating of the loan associated with the insurance policy as secured with the IP assets.

2. The system of claim 1, the operations further comprising:
querying, during a term of the loan, one or more databases for updated IP data associated with the IP assets, the updated IP data indicating differences between the IP data prior to the loan and the IP data after issuance of the loan;
generating, utilizing the one or more predictive machine learning models, updated assessment data;
generating, utilizing the updated assessment data, updated valuation data indicating an updated value of the IP assets;
determining that the updated value of the IP assets is within a threshold amount of the value of the IP assets; and
in response to the updated value being within the threshold amount, causing the first secure user interface to display an indication that the value of the IP assets has been maintained.

3. The system of claim 1, the operations further comprising:
determining, utilizing a trained machine learning model configured to map products and services to IP assets, one or more potential purchasers in a technology category that the IP assets are associated with;
determining, utilizing historical data associated with the one or more potential purchasers, a probability value that the one or more potential purchasers would purchase the IP assets; and
including, in the assessment data, an indicator of the one or more potential purchasers and the probability value.

4. The system of claim 1, the operations further comprising:
generating, utilizing a machine learning model, historical term data indicating associations between prior insurance policy terms and prior assessment data;
storing the historical term data in a database;
in response to generating the assessment data, querying the database to determine the associations related to the assessment data;
identifying, from the database, a set of the prior assessment data that corresponds to the assessment data; and
including, in the insurance policy, a set of the prior insurance policy terms associated with the set of the prior assessment data.

5. A system, comprising:
one or more processors; and
non-transitory computer-readable media storing computer-executable instructions that, when executed by the one or more processors, cause the one or more processors to perform operations comprising:
developing one or more machine learning models configured to produce, as output, assessment data indicating an assessment of multiple metrics associated with intellectual property (IP) assets;
receiving, from at least a first device associated with an entity that owns the IP assets, IP data associated with the IP assets;
generating, based at least in part on the one or more machine learning models, the assessment data;
generating, based at least in part on the assessment data, valuation data indicating a value of the IP assets;
sending the valuation data to a second device associated with a lender;
facilitating issuance of a loan from the lender to the entity, at least a portion of the terms of the loan determined automatically from the valuation data;
procuring an insurance policy from an insurer where an insurance payout is triggered when the entity defaults on the loan, the loan secured using the IP assets as collateral, at least a portion of the terms of the insurance policy determined automatically from the valuation data; and
receiving, from a third device associated with a rating agency, a rating of the loan associated with the insurance policy as secured with the IP assets.

6. The system of claim 5, the operations further comprising:
querying, during a term of the loan, one or more databases for updated IP data associated with the IP assets;
generating updated assessment data;
generating, based at least in part on the updated assessment data, updated valuation data indicating an updated value of the IP assets;
determining that the updated value of the IP assets is within a threshold amount of the value of the IP assets; and
based at least in part on the updated value being within the threshold amount, generating an indication that the value of the IP assets has been maintained.

7. The system of claim 5, the operations further comprising:
determining one or more potential purchasers in a technology category that the IP assets are associated with;
determining, based at least in part on historical data associated with the one or more potential purchasers, a probability value that the one or more potential purchasers would purchase the IP assets; and
including, in the assessment data, an indicator of the one or more potential purchasers and the probability value.

8. The system of claim 5, the operations further comprising:
generating historical term data indicating associations between prior insurance policy terms and prior assessment data;
identifying a set of the prior assessment data that corresponds to the assessment data; and
including, in the insurance policy, a set of the prior insurance policy terms associated with the set of the prior assessment data.

9. The system of claim 5, the operations further comprising:
generating a machine learning model configured to determine factors that impact the rating;
training the machine learning model utilizing, as a training dataset, feedback data associated with prior ratings of prior loans secured using other IP assets such that a trained machine learning model is generated;
determining, utilizing the trained machine learning model, a group of the factors that are likely to impact the rating associated with the loan;
identifying types of assessment data associated with the group of the factors; and
querying the entity for the types of the assessment data.

10. The system of claim 5, the operations further comprising:
determining one or more triggers events that, when determined to occur during a term of the loan, causes the system to:
determine one or more potential purchasers in a technology category that the IP assets are associated with; and
determine, based at least in part on historical data associated with the one or more potential purchasers, a probability value that the one or more potential purchasers would purchase the IP assets;
detecting occurrence of at least one of the one or more trigger event; and
in response to detecting the occurrence:
determining the one or more potential purchasers in the technology category; and
determining the probability value that the one or more potential purchasers will purchase the IP assets.

11. The system of claim 5, the operations further comprising:
generating an IP terminal configured to selectively display information to the entity, the lender, the insurer, and the rating agency;
generating, for use in association with the IP terminal, a first user interface configured to secure first data sent between the entity and the lender;
generating, for use in association with the IP terminal, a second user interface configured to secure second data sent between the lender and the insurer; and
generating, for use in association with the IP terminal, a third user interface configured to secure third data sent between the rating agency and at least one of the lender or the insurer.

12. The system of claim 5, the operations further comprising:
determining, utilizing the assessment data, a coverage score associated with the IP assets, the coverage score indicating how well the IP assets are associated with a business associated with the entity and how much of a technological area associated with the entity is covered by the IP assets;
determining, utilizing the assessment data, an opportunity score associated with the IP assets, the opportunity score indicating an ability of the entity to increase coverage of the IP assets for the technological area;
determining, utilizing the assessment, data, an exposure score associated with the IP assets, the exposure score indicating a likelihood of IP-related exposure to the entity; and
generating the rating based at least in part on the coverage score, the opportunity score, and the exposure score.

13. A method, comprising:
generating one or more machine learning models configured to generate, as output, assessment data indicating an assessment of multiple metrics associated with intellectual property (IP) assets;
receiving, from a first device associated with an entity that owns the IP assets, IP data associated with the IP assets;
generating, based at least in part on the one or more machine learning models, the assessment data;
generating, based at least in part on the assessment data, valuation data indicating a value of the IP assets;
sending the valuation data to a second device associated with a lender;
facilitating issuance of a loan from the lender to the entity, at least a portion of the terms of the loan determined automatically from the valuation data;
procuring an insurance policy from an insurer where an insurance payout is triggered when the entity defaults on the loan, the loan secured using the IP assets as collateral, at least a portion of the terms of the insurance policy determined automatically from the valuation data; and
receiving, from a third device associated with a rating agency, a rating of the loan associated with the insurance policy as secured with the IP assets.

14. The method of claim 13, further comprising:
querying, during a term of the loan, one or more databases for updated IP data associated with the IP assets;
generating updated assessment data;
generating, based at least in part on the updated assessment data, updated valuation data indicating an updated value of the IP assets;
determining that the updated value of the IP assets is within a threshold amount of the value of the IP assets; and
based at least in part on the updated value being within the threshold amount, generating an indication that the value of the IP assets has been maintained.

15. The method of claim 13, further comprising:
determining one or more potential purchasers in a technology category that the IP assets are associated with;
determining, based at least in part on historical data associated with the one or more potential purchasers, a probability value that the one or more potential purchasers would purchase the IP assets; and
including, in the assessment data, an indicator of the one or more potential purchasers and the probability value.

16. The method of claim 13, further comprising:
generating historical term data indicating associations between prior insurance policy terms and prior assessment data;
identifying a set of the prior assessment data that corresponds to the assessment data; and
including, in the insurance policy, a set of the prior insurance policy terms associated with the set of the prior assessment data.

17. The method of claim 13, further comprising:
generating a machine learning model configured to determine factors that impact the rating;
training the machine learning model utilizing, as a training dataset, feedback data associated with prior ratings of prior loans secured using other IP assets such that a trained machine learning model is generated;
determining, utilizing the trained machine learning model, a group of the factors that are likely to impact the rating associated with the loan;
identifying types of assessment data associated with the group of the factors; and
querying the entity for the types of the assessment data.

18. The method of claim 13, further comprising:
determining one or more triggers events that, when determined to occur during a term of the loan, causes a system to:
determine one or more potential purchasers in a technology category that the IP assets are associated with; and
determine, based at least in part on historical data associated with the one or more potential purchasers, a probability value that the one or more potential purchasers would purchase the IP assets;
detecting occurrence of at least one of the one or more trigger event; and
in response to detecting the occurrence:
determining the one or more potential purchasers in the technology category; and
determining the probability value that the one or more potential purchasers will purchase the IP assets.

19. The method of claim 13, further comprising:
generating an IP terminal configured to selectively display information to the entity, the lender, the insurer, and the rating agency;
generating, for use in association with the IP terminal, a first user interface configured to secure first communications between the entity and the lender;
generating, for use in association with the IP terminal, a second user interface configured to secure second communications between the lender and the insurer; and
generating, for use in association with the IP terminal, a third user interface configured to secure third communications between the rating agency and at least one of the lender or the insurer.

20. The method of claim 13, further comprising:
determining, utilizing the assessment data, a coverage score associated with the IP assets, the coverage score indicating how well the IP assets are associated with a business associated with the entity and how much of a technological area associated with the entity is covered by the IP assets;
determining, utilizing the assessment data, an opportunity score associated with the IP assets, the opportunity score indicating an ability of the entity to increase coverage of the IP assets for the technological area;
determining, utilizing the assessment, data, an exposure score associated with the IP assets, the exposure score indicating a likelihood of IP exposure to the entity; and
generating the rating based at least in part on the coverage score, the opportunity score, and the exposure score.
